(19) United States
(12) Patent Application Publication
(10) Pub. No.: US 2026/0107229 A1
(43) Pub. Date: Apr. 16, 2026

(54) LOW POWER WAKE UP SIGNAL CONTROL BIT UTILIZATION

(71) Applicant: QUALCOMM Incorporated, San Diego, CA (US)

(72) Inventors: Jung Ho RYU, Englewood Cliffs, NJ (US); Igor GUTMAN, Hod HaSharon (IL); Hemant SAGGAR, San Diego, CA (US); Jelena DAMNJANOVIC, Del Mar, CA (US); Kazuki TAKEDA, Minato-ku (JP); Tao LUO, San Diego, CA (US); Junyi LI, Greentown, PA (US)

(21) Appl. No.: 19/347,561

(22) Filed: Oct. 1, 2025

Related U.S. Application Data
(60) Provisional application No. 63/706,017, filed on Oct. 10, 2024.

(51) Int. Cl. H04W 52/02

(52) U.S. Cl. CPC H04W 52/0235; H04W 52/0274

(57) ABSTRACT

Methods, systems, and devices for wireless communications are described. A user equipment (UE) may perform an operation indicated by control bits in a low power wake up signal (LP-WUS), where the control bits may indicate the operation based on a type of the LP-WUS. The type of the LP-WUS may be based on whether a control channel monitoring occasion associated with the LP-WUS is within an active duration of a discontinuous reception (DRX) cycle, and the UE may determine the type of the LP-WUS based on resources for receiving the LP-WUS, the resources of the control channel monitoring occasion associated with the LP-WUS, a control bit indicated by the LP-WUS, or any combination thereof. The control bits may include one or more of a bitmap format and a codepoint format, where the format of the control bits may be based on the type of the LP-WUS.

### CROSS REFERENCES

The present Application for Patent claims benefit of U.S. Provisional Patent Application No. 63/706,017 by RYU et al., entitled “LOW POWER WAKE UP SIGNAL CONTROL BIT UTILIZATION,” filed Oct. 10, 2024, assigned to the assignee hereof, and expressly incorporated herein.

### INTRODUCTION

The following relates to wireless communications, including low power wake up signal control bit utilization. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving a wake up signal (WUS) (e.g., a low power WUS (LP-WUS)) that corresponds to a control channel monitoring occasion for the UE and indicates control bits via a low power waveform that is receivable by a low power radio of the UE, where the low power radio is different from a main radio of the UE and performing an operation indicated by the control bits according to a type of the WUS.

A UE for wireless communication is described. The UE may include one or more memories storing processor executable code, and one or more processors coupled with the one or more memories. The one or more processors may individually or collectively be operable to execute the code to cause the UE to receive a WUS that corresponds to a control channel monitoring occasion for the UE and indicates control bits via a low power waveform that is receivable by a low power radio of the UE, where the low power radio is different from a main radio of the UE and perform an operation indicated by the control bits according to a type of the WUS.

Another UE for wireless communication is described. The UE may include means for receiving a WUS that corresponds to a control channel monitoring occasion for the UE and indicates control bits via a low power waveform that is receivable by a low power radio of the UE, where the low power radio is different from a main radio of the UE and means for performing an operation indicated by the control bits according to a type of the WUS.

A non-transitory computer-readable medium storing code for wireless communication is described. The code may include instructions executable by one or more processors to receive a WUS that corresponds to a control channel monitoring occasion for the UE and indicates control bits via a low power waveform that is receivable by a low power radio of the UE, where the low power radio is different from a main radio of the UE and perform an operation indicated by the control bits according to a type of the WUS.

In some examples of the method, UEs, and non-transitory computer-readable medium described herein, the type of the WUS may be based on whether the control channel monitoring occasion occurs within an active duration of a discontinuous reception cycle.

In some examples of the method, UEs, and non-transitory computer-readable medium described herein, a value of a first control bit of the control bits indicates the type of the WUS.

In some examples of the method, UEs, and non-transitory computer-readable medium described herein, the operation may be performed based on one or more remaining control bits of the control bits that exclude the first control bit, and the one or more remaining control bits indicate the operation based on the value of the first control bit.

In some examples of the method, UEs, and non-transitory computer-readable medium described herein, the control bits include a bitmap format to indicate the operation, a value of a control bit of the control bits indicates to perform the operation, or the control bits include a codepoint format to indicate the operation, and a codepoint value of one or more of the control bits indicates to perform the operation.

In some examples of the method, UEs, and non-transitory computer-readable medium described herein, the operation may be indicated by the bitmap format of the control bits or the codepoint format of the control bits based on the type of the WUS.

In some examples of the method, UEs, and non-transitory computer-readable medium described herein, a value of a first control bit of the control bits indicates whether one or more remaining control bits of the control bits that exclude the first control bit include the bitmap format or the codepoint format to indicate the operation.

In some examples of the method, UEs, and non-transitory computer-readable medium described herein, a resource in which the WUS may be received indicates the type of the WUS.

Some examples of the method, UEs, and non-transitory computer-readable medium described herein may further include operations, features, means, or instructions for receiving control signaling that indicates one or more first WUS monitoring occasions that corresponds to WUSs of a first type and indicates one or more second WUS monitoring occasions that correspond to WUSs of a second type, where the WUS may be received based on the one or more first WUS monitoring occasions or the one or more second WUS monitoring occasions.

In some examples of the method, UEs, and non-transitory computer-readable medium described herein, the type of the WUS may be associated with an active duration of a discontinuous reception cycle that includes the control channel monitoring occasion, and performance of the operation includes one or more of maintenance of an inactivity timer as deactivated after reception of a control channel message during the control channel monitoring occasion, a changing of a transmission configuration indicator state associated with control channel monitoring, a monitoring for WUSs by the low power radio of the UE, deactivation of the discontinuous reception cycle, activation of WUS-triggered control channel monitoring, a skipping of monitoring of one or more control channel monitoring occasions, a switching of a search space set group associated with the UE, and activation of communications via a secondary cell, a frequency range, or both.

Some examples of the method, UEs, and non-transitory computer-readable medium described herein may further include operations, features, means, or instructions for initiating an on duration timer associated with a discontinuous reception cycle based on the type of the WUS that corresponds to an active duration of the discontinuous reception cycle that includes the control channel monitoring occasion.

Some examples of the method, UEs, and non-transitory computer-readable medium described herein may further include operations, features, means, or instructions for monitoring for the WUS outside of an active duration of a discontinuous reception cycle in accordance with a WUS monitoring configuration, where the WUS may be received based on monitoring for the WUS.

Some examples of the method, UEs, and non-transitory computer-readable medium described herein may further include operations, features, means, or instructions for monitoring for the WUS within an active duration of a discontinuous reception cycle in accordance with a WUS monitoring configuration.

In some examples of the method, UEs, and non-transitory computer-readable medium described herein, the type of the WUS may be associated with an active duration of a discontinuous reception cycle that does not include the control channel monitoring occasion, and performance of the operation includes one or more of a skipping of monitoring of one or more WUS monitoring occasions, initiation of the monitoring for a control channel message during the control channel monitoring occasion a time interval after the WUS may be received, activation of the main radio of the UE to an alertness level, transmission of a sounding reference signal by one or more antennas of the UE, transmission of channel state information by the one or more antennas of the UE, a monitoring of a WUS monitoring occasion by the low power radio of the UE, deactivation of the main radio, and a changing of a WUS monitoring configuration of the UE.

A method for wireless communication by a network entity is described. The method may include outputting a WUS that corresponds to a control channel monitoring occasion for a UE and indicates control bits via a low power waveform receivable by a low power radio that is different from a main radio, where the control bits indicate one or more operations to be performed at the UE according to a type of the WUS and communicating with the UE based on the one or more operations indicated by the control bits according to the type of the WUS.

A network entity for wireless communication is described. The network entity may include one or more memories storing processor executable code, and one or more processors coupled with the one or more memories. The one or more processors may individually or collectively be operable to execute the code to cause the network entity to output a WUS that corresponds to a control channel monitoring occasion for a UE and indicates control bits via a low power waveform receivable by a low power radio that is different from a main radio, where the control bits indicate one or more operations to be performed at the UE according to a type of the WUS and communicate with the UE based on the one or more operations indicated by the control bits according to the type of the WUS.

Another network entity for wireless communication is described. The network entity may include means for output a WUS that corresponds to a control channel monitoring occasion for a UE and indicates control bits via a low power waveform receivable by a low power radio that is different from a main radio, where the control bits indicate one or more operations to be performed at the UE according to a type of the WUS and means for communicating with the UE based on the one or more operations indicated by the control bits according to the type of the WUS.

A non-transitory computer-readable medium storing code for wireless communication is described. The code may include instructions executable by one or more processors to output a WUS that corresponding to a control channel monitoring occasion for a UE and indicates control bits via a low power waveform receivable by a low power radio that is different from a main radio, where the control bits indicate one or more operations to be performed at the UE according to a type of the WUS and communicate with the UE based on the one or more operations indicated by the control bits according to the type of the WUS.

In some examples of the method, network entities by an apparatus for wireless communication at a network entities, and non-transitory computer-readable medium described herein, the type of the WUS may be based on whether the control channel monitoring occasion occurs within an active duration of a discontinuous reception cycle.

In some examples of the method, network entities by an apparatus for wireless communication at a network entities, and non-transitory computer-readable medium described herein, a value of a first control bit of the control bits indicates the type of the WUS, the one or more operations may be performed based on one or more remaining control bits of the control bits that exclude the first control bit, and the one or more remaining control bits indicate the one or more operations based on the value of the first control bit.

In some examples of the method, network entities by an apparatus for wireless communication at a network entities, and non-transitory computer-readable medium described herein, the control bits include a bitmap format to indicate the one or more operations, a value of a control bit of the control bits indicates to perform the one or more operations, or the control bits include a codepoint format to indicate the one or more operations, a codepoint value of one or more of the control bits indicates to perform the one or more operations.

In some examples of the method, network entities by an apparatus for wireless communication at a network entities, and non-transitory computer-readable medium described herein, the one or more operations may be indicated by the bitmap format of the control bits or the codepoint format of the control bits based on the type of the WUS.

A method for wireless communications by a UE is described. The method may include receiving a WUS corresponding to a control channel monitoring occasion for the UE and indicating control bits via a low power waveform, monitoring for a control channel message during the control channel monitoring occasion based on the WUS, and performing an operation indicated by the control bits according to a type of the WUS.

A UE for wireless communications is described. The UE may include one or more memories storing processor executable code, and one or more processors coupled with the one or more memories. The one or more processors may individually or collectively be operable to execute the code to cause the UE to receive a WUS corresponding to a control channel monitoring occasion for the UE and indicating control bits via a low power waveform, monitor for a control channel message during the control channel monitoring occasion based on the WUS, and perform an operation indicated by the control bits according to a type of the WUS.

Another UE for wireless communications is described. The UE may include means for receiving a WUS corresponding to a control channel monitoring occasion for the UE and indicating control bits via a low power waveform, means for monitoring for a control channel message during the control channel monitoring occasion based on the WUS, and means for performing an operation indicated by the control bits according to a type of the WUS.

A non-transitory computer-readable medium storing code for wireless communications is described. The code may include instructions executable by one or more processors to receive a WUS corresponding to a control channel monitoring occasion for the UE and indicating control bits via a low power waveform, monitor for a control channel message during the control channel monitoring occasion based on the WUS, and perform an operation indicated by the control bits according to a type of the WUS.

In some examples of the method, UEs, and non-transitory computer-readable medium described herein, the type of the WUS may be based on whether the control channel monitoring occasion occurs within an active duration of a discontinuous reception (DRX) cycle.

In some examples of the method, UEs, and non-transitory computer-readable medium described herein, a value of a first control bit of the control bits indicates the type of the WUS.

In some examples of the method, UEs, and non-transitory computer-readable medium described herein, the operation may be performed based on one or more remaining control bits of the control bits that exclude the first control bit and the one or more remaining control bits indicate the operation based on the value of the first control bit.

In some examples of the method, UEs, and non-transitory computer-readable medium described herein, the control bits include a bitmap format to indicate the operation, where a value of a control bit of the control bits indicates to perform the operation and the control bits include a codepoint format to indicate the operation, where a codepoint value of one or more of the control bits indicates to perform the operation.

In some examples of the method, UEs, and non-transitory computer-readable medium described herein, the operation may be indicated by the bitmap format of the control bits or the codepoint format of the control bits based on the type of the WUS.

In some examples of the method, UEs, and non-transitory computer-readable medium described herein, a value of a first control bit of the control bits indicate whether one or more remaining control bits of the control bits excluding the first control bit include the bitmap format or the codepoint format to indicate the operation.

In some examples of the method, UEs, and non-transitory computer-readable medium described herein, a resource in which the WUS may be received indicates the type of the WUS.

Some examples of the method, UEs, and non-transitory computer-readable medium described herein may further include operations, features, means, or instructions for receiving control signaling that indicates one or more first WUS monitoring occasions corresponding to WUSs of a first type and indicates one or more second WUS monitoring occasions corresponding to WUSs of a second type, where the WUS may be received based on the one or more first WUS monitoring occasions or the one or more second WUS monitoring occasions.

In some examples of the method, UEs, and non-transitory computer-readable medium described herein, the low power waveform includes an on-off-keying (OOK) waveform received by a low power radio of the UE and the OOK waveform includes a sequence of high amplitude durations, low amplitude durations, or both, corresponding to respective high values, low values, or both, of the control bits.

In some examples of the method, UEs, and non-transitory computer-readable medium described herein, the type of the WUS may be associated with the control channel monitoring occasion occurring within an active duration of a DRX cycle and the operation includes one or more of maintaining an inactivity timer deactivated after reception of the control channel message, changing a transmission configuration indicator state associated with control channel monitoring, monitoring for WUSs using a low power radio of the UE, deactivating the DRX cycle, activating WUS-triggered control channel monitoring, skipping monitoring of one or more control channel monitoring occasions, switching a search space set group associated with the UE, and activating communications via a secondary cell, a frequency range, or both.

Some examples of the method, UEs, and non-transitory computer-readable medium described herein may further include operations, features, means, or instructions for initiating an on duration timer associated with a DRX cycle based on the type of the WUS being associated with the control channel monitoring occasion being within an active duration of the DRX cycle.

Some examples of the method, UEs, and non-transitory computer-readable medium described herein may further include operations, features, means, or instructions for monitoring for the WUS outside of an active duration of a DRX cycle according to a WUS monitoring configuration, where the WUS may be received based on monitoring for the WUS.

Some examples of the method, UEs, and non-transitory computer-readable medium described herein may further include operations, features, means, or instructions for monitoring for the WUS within an active duration of a DRX cycle according to a WUS monitoring configuration, where the WUS may be received based on monitoring for the WUS.

In some examples of the method, UEs, and non-transitory computer-readable medium described herein, the type of the WUS may be associated with the control channel monitoring occasion not occurring within an active duration of a DRX cycle and the operation includes one or more of skipping monitoring of one or more WUS monitoring occasions, beginning the monitoring for the control channel message a time interval after the WUS may be received, activating a main radio of the UE to an alertness level, transmitting a sounding reference signal using the main radio of the UE, transmitting channel state information using the main radio of the UE, monitoring a WUS monitoring occasion using a low power radio of the UE, deactivating the main radio, and changing a WUS monitoring configuration of the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports low power wake up signal (LP-WUS) control bit utilization in accordance with one or more aspects of the present disclosure.

FIG. 2 shows an example of a wireless communications system that supports LP-WUS control bit utilization in accordance with one or more aspects of the present disclosure.

FIG. 3 shows examples of resource diagrams that support LP-WUS control bit utilization in accordance with one or more aspects of the present disclosure.

FIGS. 4 and 5 show block diagrams of devices that support LP-WUS control bit utilization in accordance with one or more aspects of the present disclosure.

FIG. 6 shows a block diagram of a communications manager that supports LP-WUS control bit utilization in accordance with one or more aspects of the present disclosure.

FIG. 7 shows a diagram of a system including a device that supports LP-WUS control bit utilization in accordance with one or more aspects of the present disclosure.

FIG. 8 shows a flowchart illustrating methods that support LP-WUS control bit utilization in accordance with one or more aspects of the present disclosure

FIG. 9 shows a flowchart illustrating methods that support LP-WUS control bit utilization in accordance with one or more aspects of the present disclosure

FIGS. 10 and 11 show block diagrams of devices that support LP-WUS control bit utilization in accordance with one or more aspects of the present disclosure.

FIG. 12 shows a block diagram of a communications manager that supports LP-WUS control bit utilization in accordance with one or more aspects of the present disclosure.

FIG. 13 shows a diagram of a system including a device that supports LP-WUS control bit utilization in accordance with one or more aspects of the present disclosure.

FIG. 14 shows a flowchart illustrating methods that support LP-WUS control bit utilization in accordance with one or more aspects of the present disclosure.

### DETAILED DESCRIPTION

Some wireless communications systems may utilize wake up signals (WUSs) to alert a user equipment (UE) in a low power mode to begin monitoring for one or more control channel messages (e.g., to monitor a control channel such as a physical downlink control channel (PDCCH), to perform PDCCH monitoring) during a control channel monitoring occasion (e.g., a PDCCH monitoring occasion). The low power mode of the UE may be associated with a discontinuous reception (DRX) cycle configured at the UE, or may be associated with another low power mode operation of the UE. In some cases, a WUS may be of a first or a second type, based on a control channel monitoring occasion associated with the WUS. For example, a WUS of the first type may alert the UE to monitor a control channel monitoring occasion that is within an active duration of a DRX cycle (e.g., based on the DRX cycle being configured and activated at the UE), and a WUS of a second type may alert the UE to monitor a control channel monitoring occasion that is not within an active duration of a DRX cycle (e.g., within an inactive duration of the DRX cycle, based on the DRX cycle not being configured or activated at the UE, unassociated with the DRX cycle). The WUS may be a low power-WUS (LP-WUS), which may be capable of carrying a limited quantity of control bits (e.g., up to eight control bits) via a low power waveform (e.g., which may be different from an orthogonal frequency division multiplexed (OFDM) waveform). Indicating one or more operations for the UE to perform (e.g., in addition to the control channel monitoring) via the limited quantity of control bits may improve wireless communication resource efficiency by reducing additional signaling to indicate the one or more operations, and the one or more operations may be dependent on a type of the WUS. Thus, techniques for using the limited quantity of control bits to indicate multiple operations for the UE to perform may enhance wireless resource efficiency and reduce signaling overhead.

According to techniques described herein, a UE may perform an operation (e.g., one or more operations) indicated by control bits (e.g., one or more control bits) in an LP-WUS, where the control bits may indicate the operation based on a type of the LP-WUS. In some cases, the UE may determine the type of the LP-WUS based on resources used to receive the LP-WUS, based on whether a control channel monitoring occasion associated with the LP-WUS is within an active duration of a DRX cycle (e.g., or not), or based on a first control bit of the control bits indicated by the LP-WUS. If the first control bit indicates the type of the LP-WUS, one or more remaining control bits of the LP-WUS (e.g., excluding the first control bit) may indicate the operation based on a value of the first control bit. In some cases, the control bits of the LP-WUS may include a bitmap format (e.g., where a value of each control bit may indicate whether to perform one or more corresponding operations) or a codepoint format (e.g., where a codepoint value (e.g., a binary value) of the control bits may indicate to perform one or more operations). In some cases, the format of the control bits (e.g., either bitmap or codepoint) may be based on the type of the LP-WUS. Additionally, or alternatively, a second control bit of the control bits (e.g., additionally, or alternatively, to the first control bit) may indicate a format of one or more remaining control bits for indicating the operation. Accordingly, the limited quantity of bits indicated by the LP-WUS may indicate multiple operations for the UE to perform based on a type of the LP-WUS, which may reduce signaling overhead associated with requesting such operations at the UE, and may reduce latency and power usage at the UE associated with receiving separate signaling to request such operations at the UE.

For example, the operations indicated by the LP-WUS may include one or more of maintaining an inactivity timer associated with the a DRX cycle deactivated after reception of a control channel message, changing or activating/deactivating a transmission configuration indicator (TCI) state associated with control channel monitoring, monitoring for WUSs using the low power radio of the UE, deactivating the DRX cycle, deactivating the use of the first type of LP-WUS and activating the use of the second type of LP-WUS, activating or deactivating LP-WUS-triggered control channel monitoring, skipping monitoring of one or more control channel monitoring occasions, switching a search space set group (SSSG) associated with the UE, activating communications via a secondary cell (SCell), activating communications via a frequency range, skipping monitoring of one or more WUS monitoring occasions, beginning monitoring for control channel messages a time offset after the LP-WUS is received, waking up the main radio of the UE to transmit SRS and deactivating the main radio, activating the main radio to an alertness level, transmitting an SRS using the main radio of the UE, transmitting CSI report using the main radio of the UE, monitoring a WUS monitoring occasion using a low power radio of the UE, deactivating the main radio, changing the LP-WUS monitoring configuration of the UE, activating/deactivating LP-WUS monitoring configuration of the UE, activating/deactivating C-DRX operation, changing C-DRX configuration, activating or deactivating DCP, or any combination thereof.

Aspects of the disclosure are initially described in the context of wireless communications systems. Aspects of the disclosure are also described with respect to resource diagrams. Aspects of the disclosure are further illustrated by and described with reference to apparatus diagrams, system diagrams, and flowcharts that relate to LP-WUS control bit utilization.

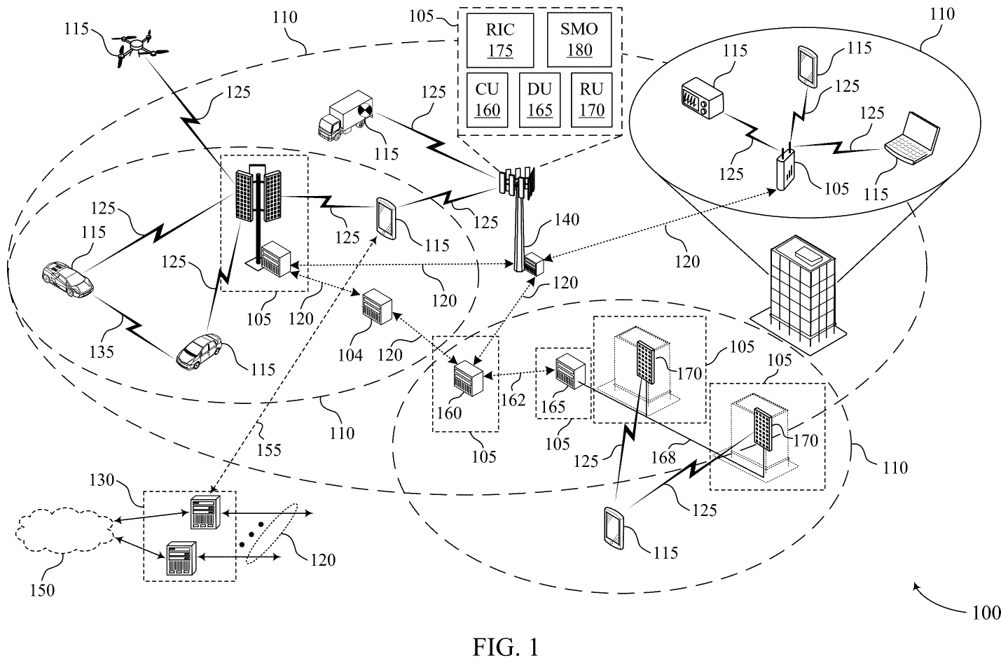

FIG. 1 shows an example of a wireless communications system 100 that supports LP-WUS control bit utilization in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support LP-WUS control bit utilization as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. In some cases, beamforming may be based on a transmission configuration indicator (TCI) state associated with the UE 115. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

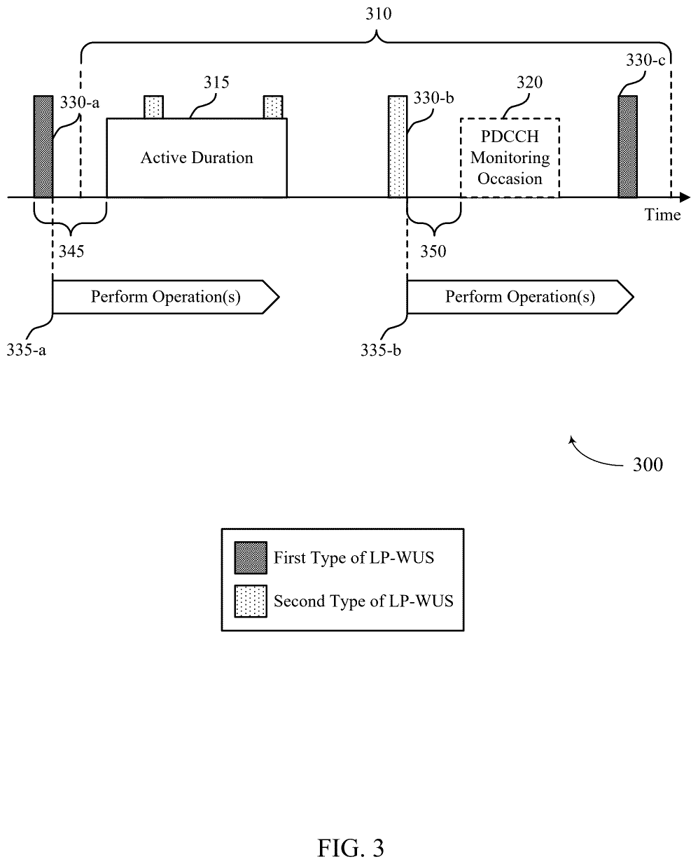

According to techniques described herein, a UE 115 may perform an operation (e.g., one or more operations) indicated by control bits (e.g., one or more control bits) in an LP-WUS received from a network entity 105, where the control bits may indicate the operation based on a type of the LP-WUS. In some cases, the UE 115 may determine the type of the LP-WUS based on resources (e.g., an LP-WUS monitoring occasion) used to receive the LP-WUS, based on whether a control channel monitoring occasion associated with (e.g., indicated by, activated by) the LP-WUS is within an active duration of a DRX cycle (e.g., or not), or based on a first control bit of the control bits of the LP-WUS. If the first control bit indicates the type of the LP-WUS, one or more remaining control bits of the LP-WUS (e.g., excluding the first control bit) may indicate the operation based on a value of the first control bit. In some cases, the control bits of the LP-WUS may include a bitmap format or a codepoint format (e.g., as described with respect to FIG. 3). In some cases, the format of the control bits (e.g., either bitmap or codepoint) may be based on the type of the LP-WUS, and a second control bit of the control bits (e.g., additionally or alternatively to the first control bit) may indicate a format of one or more remaining control bits for indicating the operation. Accordingly, the limited quantity of control bits of the LP-WUS may indicate multiple operations for the UE 115 to perform based on a type of the LP-WUS, which may reduce signaling overhead associated with requesting such operations at the UE 115, and may reduce latency and power usage at the UE 115 associated with receiving separate signaling to request such operations at the UE 115.

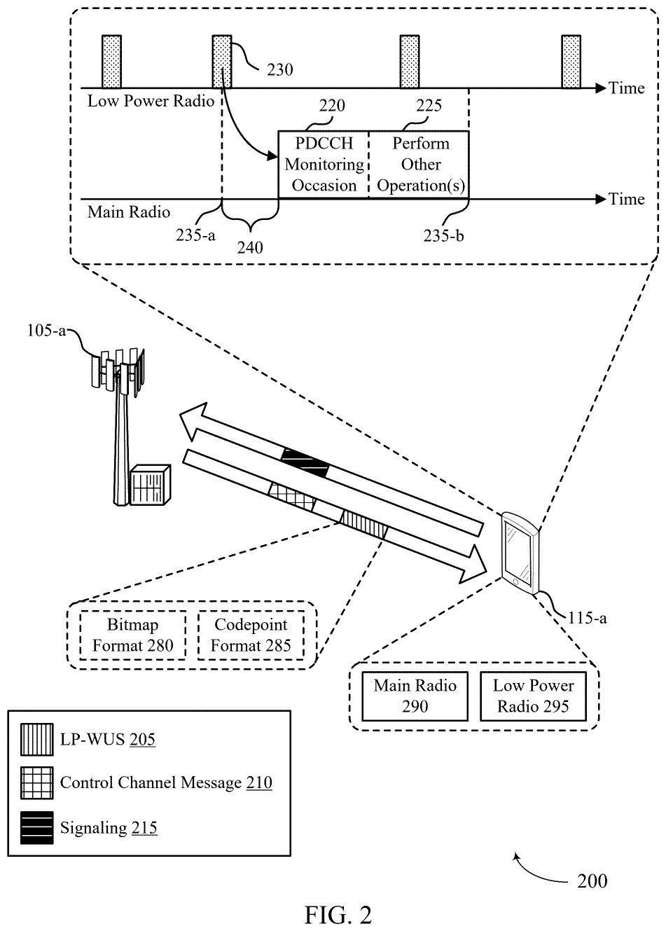

FIG. 2 shows an example of a wireless communications system 200 that supports LP-WUS control bit utilization in accordance with one or more aspects of the present disclosure. Some aspects of the wireless communications system 200 may implement or be implemented by aspects of FIG. 1. For example, the wireless communications system 200 may include a UE 115-a and a network entity 105-a, which may be examples of the UEs 115 and the network entities 105 as described herein. In some aspects, the UE 115-a may receive an LP-WUS 205 (e.g., a WUS) from the network entity 105-a. The UE 115-a may monitor for a control channel message 210 during a PDCCH monitoring occasion 220 and perform other operation(s) at 225 based on control bits and a type of the LP-WUS 205.

In some wireless communications systems, the UE 115-a may monitor a control channel (e.g., PDCCH) on a serving cell associated with the network entity 105-a during an active duration (e.g., an active time) of a DRX cycle associated with the serving cell. For example, the active duration may include a duration while a DRX timer (e.g., drx-onDurationTimer, drx-InactivityTimer) configured for a DRX group (e.g., including the UE 115-a, the network entity 105-a, or both) is running (e.g., after the DRX timer is started and before the DRX timer expires). In some cases, if the UE 115-a receives a control channel message 210 (e.g., a PDCCH message) during the active duration, where the control channel message indicates a new transmission associated with the UE 115-a (e.g., a downlink message from the network entity 105-a, an uplink message from the UE 115-a, or a sidelink message to or from the UE 115-a) on a serving cell in the DRX group, the UE 115-a may start (e.g., or restart) the DRX timer (e.g., the drx-InactivityTimer), which may end the active duration at expiry. Additionally, the UE 115-a, the network entity 105-a, or both, may determine a starting subframe of the DRX cycle based on a configuration parameter such as drx-LongCycleStartOffset.

In some cases, the UE 115-a may receive a downlink control information (DCI) message for power savings (DCP), which may be a WUS transmitted via DCI signaling (e.g., using an OFDM waveform). For example, the DCP may be a DCI with a format 2-6 (e.g., as described according to a technical standard) with cyclic redundancy check (CRC) scrambled by a power saving-radio network temporary identifier (PS-RNTI). Due to the OFDM waveform of the DCP, the UE 115-a may receive the DCP using a main radio 290 of the UE 115-a (e.g., and the UE 115-a may not be able to receive the DCP using a low power radio 295 of the UE 115-a). In some cases, because the UE 115-a may monitor for the DCP using the main radio 290, the UE 115-a may not be capable of turning off the main radio 290 for relatively long periods of time (e.g., during an inactive duration of the DRX cycle), and the UE 115-a may not put the main radio 290 into a deep sleep mode (e.g., completely turned off) based on monitoring for the DCP. Thus, using the DCP as a WUS may limit a power savings of the DRX cycle at the UE 115-a.

In some cases, a search time (e.g., a monitoring occasion) for the DCP may be indicated by a time offset before a start of the DRX active duration at the UE 115-a, and may be indicated by a parameter ps-Offset-r16. For example, ps-Offset-r16 may indicate the start of a search time for DCP relative to a start of the active duration of the DRX cycle (e.g., the start of the drx-onDurationTimer for a long DRX cycle, as described according to a technical standard). In some cases, ps-Offset-r16 may have a value that indicates a multiple of 0.125 milliseconds (ms). For example, a ps-Offset-r16 value of 1 may correspond to 0.125 ms, a value of 2 may correspond to 0.25 ms, and so on.

A connected mode DRX (C-DRX) (e.g., referred to herein also as DRX) may be a UE power saving procedure in which the UE 115-a periodically enter an active duration (e.g., an on duration, wake up, activates a main radio 290 of the UE 115-a) to monitor a control channel for a control channel message 210 from the network entity 105-a. When the UE 115-a is not monitoring the control channel (e.g., during an inactive period of the C-DRX cycle), the UE 115-a (e.g., including the main radio 290 of the UE 115-a) may enter a sleep mode (e.g., power saving mode, deep sleep mode). In some cases, the periodicity of the C-DRX active duration may be fixed once configured, and the UE 115-a may wake up the main radio 290 to monitor the control channel in the active duration of every C-DRX cycle (e.g., even if the network entity 105-a has no control channel message 210 to transmit to the UE 115-a). Such features of C-DRX may limit the power saving gains and latency improvements associated with C-DRX. In some cases, the use of LP-WUS 205 may address one or more of these disadvantages of C-DRX.

For example, the UE 115-a may receive the LP-WUS 205 (e.g., in an LP-WUS monitoring occasion 230) to trigger control channel monitoring within an active duration (e.g., a PDCCH monitoring occasion 220) of the C-DRX configuration (e.g., of a C-DRX cycle) to increase power savings. For example, the UE 115-a may be equipped with a low power radio 295 (e.g., a low power receiver, a low power-wake up receiver (LP-WUR)) in addition to the main radio 290 of the UE 115-a for monitoring for and receiving the LP-WUS. In some cases, the UE 115-a may be capable of switching the low-power radio on and off quickly (e.g., compared to the main radio 290), and the low power radio 295 may be capable of receiving and processing relatively simple signals (e.g., low power waveforms, signaling that utilizes limited bandwidth and simpler waveforms compared to OFDM waveforms). Additionally, or alternatively, the UE 115-a may use less power to operate the low power radio 295 than the main radio 290. In other words, the low power radio 295 may be a receiver (e.g., an antenna array, associated circuitry) in the UE 115-a that is separate from the main radio 290 of the UE 115-a and includes less resource intensive components (e.g., fewer or smaller antennas, less circuitry) such that using the low power radio 295 to receive relatively simple signaling (e.g., the LP-WUS 205) may be associated with less power consumption and latency at the UE 115-a with respect to the main radio 290. In some examples, the low power radio 295 is a wake-up radio that is used to receive the LP-WUS 205, which may then trigger transition of the main radio 290 from a less active mode to a more active mode. For example, the LP-WUS 205 may indicate information by varying a subset (e.g., one) of the parameters of phase and amplitude, and the low power radio 295 may include circuitry directed to interpreting the variations in the subset of the parameters (e.g., and may not include circuitry directed to interpreting variations in the other parameters), thus reducing power usage by the low power radio 295. The low power radio 295 may use reduced power by one or more other means as well. In some cases, the UE 115-a may use the low power radio 295 to receive the LP-WUS 205 within one or more LP-WUS monitoring occasions 230 (e.g., time frequency resources used for communicating LP-WUSs 205).

In some cases, reception of the LP-WUS 205 (e.g., during the LP-WUS monitoring occasion 230) from the network entity 105-a may trigger the UE 115-a to monitor for a control channel message 210 during the PDCCH monitoring occasion 220 associated with the network entity 105-a (e.g., where the PDCCH monitoring occasion 220 may be within an active duration of a DRX cycle). For example, the UE 115-a may switch off a main radio 290 of the UE 115-a before a time 235-a to save power (e.g., the UE 115-a may enter a deep sleep mode, during an inactive duration of a DRX or C-DRX) cycle), but may maintain the low power radio 295 in an active state (e.g., using less power than the main radio 290). With the main radio 290 off, the UE 115-a may use the low power radio 295 to monitor for the LP-WUS 205 during the LP-WUS monitoring occasion 230. If the network entity 105-a transmits the LP-WUS 205 (e.g., and the UE 115-a receive the LP-WUS 205 using the low power radio 295) during the LP-WUS monitoring occasion 230, the UE 115-a may wake up (e.g., switch on, activate) the main radio 290 during the duration 240 (e.g., starting at the time 235-a) and may receive the control channel message 210 from the network entity 105-a during the PDCCH monitoring occasion 220 using the main radio 290. After the PDCCH monitoring occasion 220 (e.g., and possibly performing other operations at 225, at time 235-b), the UE 115-a may deactivate the main radio 290 again until receiving another LP-WUS 205. Thus, the UE 115-a may achieve increased power savings by triggering the control channel monitoring (e.g., within an active duration of a DRX cycle, or outside of an active duration of a DRX cycle) using the LP-WUS 205.

The LP-WUS 205 may be one of two types. For example, if the PDCCH monitoring occasion 220 is within (e.g., or is) an active duration of a DRX cycle, the LP-WUS 205 may be of a first type. That is, the first type of LP-WUS may be associated with alerting the UE 115-a to monitor a control channel monitoring occasion (e.g., PDCCH monitoring occasion 220) within an active duration of a DRX cycle. Alternatively, if the PDCCH monitoring occasion 220 is not within the active duration of the DRX cycle (e.g., the DRX cycle is not active, or the PDCCH monitoring occasion 220 is within the inactive duration of the DRX cycle), the LP-WUS 205 may be of the second type. For example, the second type of LP-WUS may be associated with alerting the UE 115-a to monitor a control channel monitoring occasion (e.g., a PDCCH monitoring occasion 220) that is not associated with the active duration of the DRX cycle.

In some cases, the LP-WUS 205 may indicate one or more control bits to the UE 115-a using a low power waveform. The low power waveform (e.g., and thus the LP-WUS 205) may be an on-off-keying (OOK) waveform, and the UE 115-a may use the low power radio 295 to receive the LP-WUS 205. The OOK waveform may include a sequence of high amplitude (e.g., high power, on) durations, low amplitude (e.g., low power, zero power or amplitude, off) durations (e.g., relative to a base-band power level), or both, where a high or low duration of the OOK waveform may convey a control bit (e.g., an information bit). For example, a high duration may indicate a “1” bit and a low duration may indicate a “0” bit (e.g., or vice versa). A wireless signal over time s(t) (e.g., an OFDM signal, a low power signal) may be mathematically expressed as s(t)=A(t)e^{jφ(t)}, where A(t) may represent an amplitude of the signal over time, and where φ(t) may represent a phase of the signal over time. Information in some signals may be transmitted in amplitude, phase, or both, but low power waveforms (e.g., the OOK waveforms) may use amplitude (e.g., only amplitude) to convey the control bits. In other words, the LP-WUS 205 may be a relatively simple signal compared to other signaling (e.g., OFDM signaling) due to conveying information (e.g., control bits) by varying a subset (e.g., one) of the parameters of amplitude and phase, whereas other signaling may vary both parameters. Varying fewer parameters may decrease a power used to generate, transmit, and receive the LP-WUS 205.

In some cases, the LP-WUS 205 (e.g., and low power synchronization signals (LP-SS)) may support one or more formats of OOK. For example, the LP-WUS 205 may be of the format OOK-1, which may convey one control bit in the time of one OFDM symbol (e.g., using an amplitude or power level of the OOK-1 waveform). Additionally, or alternatively, the LP-WUS 205 may be of the format OOK-4, which may convey a quantity of M (e.g., four) control bits in the time of one OFDM symbol (e.g., using the amplitude or power level of the OOK-4 waveform).

Although the low power waveform may limit a quantity of control bits that the LP-WUS 205 is capable of conveying, the techniques herein may include methods for intelligently using the limited quantity of control bits to indicate an increase amount of control information to the UE 115-a. For example, the control bits of the LP-WUS 205 may indicate one or more operations for the UE 115-a to perform based on a type of the LP-WUS 205. In one example, the UE 115-a may receive the LP-WUS 205 in the configured LP-WUS monitoring occasion 230 via the low power radio 295, where the LP-WUS 205 may indicate to the UE 115-a to monitor a PDCCH monitoring occasion 220 for a control channel message 210. In addition to monitoring the control channel, techniques described herein may allow the LP-WUS 205 to indicate one or more other functions for the UE to perform at 225, such as transmitting signaling 215 (e.g., a sounding reference signal (SRS), a CSI report), changing a configuration of the UE 115-a (e.g., switching a receive beam at the UE 115-a), or other operations or functions (e.g., further described with respect to FIG. 3). For example, such other operations may include use of the low power radio 295, the main radio 290, both, or neither, and may occur before, during, or after the PDCCH monitoring occasion 220 based on receiving the LP-WUS 205. In some cases, the control bits in the LP-WUS 205 may indicate the control information according to one or more of a bitmap format 280 and a codepoint format 285, both of which may be further described herein with respect to FIG. 3. Such techniques may avoid the UE 115-a waking up the main radio 290 to receive control signals to indicate such operations for the UE 115-a to perform, which may reduce control signaling overhead as well as latency and power usage at the UE 115-a.

FIG. 3 shows an example of a resource diagram 300 that supports LP-WUS control bit utilization in accordance with one or more aspects of the present disclosure. Some aspects of the resource diagram 300 may implement or be implemented by aspects of FIGS. 1 and 2. For example, the resource diagram 300 may include LP-WUS monitoring occasions 330 for LP-WUSs and associated PDCCH monitoring occasions 320 (e.g., including within the active duration 315 of a DRX cycle 310), which may be examples of the LP-WUS monitoring occasions 230 for LP-WUSs 205 and associated PDCCH monitoring occasions 220 as described with respect to FIGS. 1 and 2. In some aspects, the resource diagram 300 may illustrate the use of different types of LP-WUSs (e.g., the first type and the second type) received within one or more LP-WUS monitoring occasions 330. For example, the LP-WUSs may wake up a UE 115 (e.g., a main radio of the UE 115) to monitor during a PDCCH monitoring occasion 320 (e.g., or the active duration 315) and may indicate operation(s) for the UE 115 to perform based on the type of the LP-WUS.

In some cases, an LP-WUS monitoring configuration may indicate the one or more LP-WUS monitoring occasions 330 that the UE 115 may monitor to receive an LP-WUS (e.g., using the low power radio). For example, the LP-WUS monitoring configuration may be preconfigured at the UE 115, received from a network entity 105, or both. Although the resource diagram 300 may show the LP-WUS monitoring occasions 330, PDCCH monitoring occasion 320, and active duration 315 on a same line, the LP-WUS monitoring occasions 330 may be monitored by a low power radio of the UE 115 and the PDCCH monitoring occasions 320 and the active duration 315 may be monitored by a main radio of the UE 115 (e.g., as described with respect to FIG. 1). Additionally, the active duration 315 of the DRX cycle 310 may include or may be a PDCCH monitoring occasion 320 associated with the DRX cycle 310.

The resource diagram 300 may include one or more LP-WUS monitoring occasions 330 which may correspond to LP-WUSs of a first type or a second type. In some cases, LP-WUSs of the first type may be associated with (e.g., alert the UE 115 to monitor) the active duration 315 of the DRX cycle 310. That is, the first type of LP-WUS may be a replacement for DCP functions (e.g., described with respect to FIG. 2), or may be used to trigger a start of the active duration 315 (e.g., the DRX timer), during which UE may monitor PDCCH. LP-WUSs of the second type may be associated with (e.g., alert the UE 115 to monitor) PDCCH monitoring occasions 320 that are not within the active duration 315 (e.g., within an inactive duration of the DRX cycle 310) or are not associated with the DRX cycle 310 (e.g., if the UE 115 is not configured with a DRX configuration, or if the DRX configuration is not active). That is, the second type of LP-WUSs may trigger PDCCH monitoring outside the active duration (e.g., additional PDCCH monitoring occasions 320).

Some features of the resource diagram 300 may depend on whether the UE 115 has an active DRX configuration. For example, the UE 115 may not be configured with a DRX configuration (e.g., or the DRX configuration may not be active for the UE 115), and thus the active duration 315 and the DRX cycle 310 in the resource diagram 300 may be removed if the UE 115-a does not have an active DRX configuration. Additionally, LP-WUS monitoring occasions 330 shown in the resource diagram 300 to be for the first type of LP-WUS (e.g., LP-WUS monitoring occasions 330-b and 330-c) may be for the second type of LP-WUS if the UE 115 does not have an active DRX configuration.

The techniques described herein may be applicable to one or more cases. In a first case, the UE 115 may have an active DRX configuration (e.g., C-DRX configuration), and LP-WUS may be used to replace the functionality of the DCP (e.g., only to replace the DCP, as described with respect to FIG. 2). That is, LP-WUS may initiate (e.g., control, activate) the active duration 315 of the DRX cycle 310 of the UE 115, and may not be used to activate other PDCCH monitoring occasions 320. For example, the LP-WUS monitoring occasions 330 for the first type of LP-WUSs (e.g., LP-WUS monitoring occasions 330-a and 330-c) may remain, and LP-WUS monitoring occasions 330 for the second type of LP-WUS (e.g., LP-WUS monitoring occasion 330-b) may not be used in the first case. The LP-WUS monitoring configuration may cause the UE 115 to monitor the LP-WUS monitoring occasions 330 that occur a time delay 345 before the active duration 315 (e.g., before drx-onDurationTimer), which may be associated with the active duration 315. An LP-WUS monitoring occasion 330 (e.g., and the corresponding LP-WUS) may be associated with the active duration 315 by triggering the start of a drx-onDurationTimer for the active duration 315, which may cause the UE 115 to perform PDCCH monitoring within the active duration 315.

In a second case, the UE 115 may have an active DRX configuration, an inactive DRX configuration, or no DRX configuration, and the LP-WUS monitoring configuration may configure LP-WUS monitoring occasions 330 (e.g., such as LP-WUS monitoring occasion 330-b) to trigger PDCCH monitoring in PDCCH monitoring occasions 320 other than the active duration 315. That is, the LP-WUS monitoring configuration may configure LP-WUS monitoring occasions 330 for the second type of LP-WUS, but not necessarily for the first type of LP-WUS. In some cases, PDCCH monitoring occasions 320 may be unassociated with the DRX cycle 310, and may occur dynamically based on receiving an LP-WUS during the LP-WUS monitoring occasion 330-b associated with the PDCCH monitoring occasion 320. Additionally, or alternatively, if the UE 115 is configured with an active DRX configuration, the UE 115 may monitor for PDCCH messages during the active duration 315 based on the DCP or an LP-WUS of the first type. That is, in the second case, LP-WUS may also replace the functionality of the DCP (e.g., as described in the first case), such that the UE 115 may additionally monitor for the first type of LP-WUS associated with the active duration 315 (e.g., a PDCCH monitoring occasion).

In a third case, the UE 115 may have an active DRX configuration, where the LP-WUS monitoring configuration may configure LP-WUS monitoring occasions 330 for the first type of LP-WUS and the second type of LP-WUS, but only one of the types of LP-WUS monitoring occasions 330 may be activated at a time. That is, the UE 115 may either monitor LP-WUS monitoring occasions 330 associated with the first type of LP-WUS (e.g., LP-WUS monitoring occasions 330-a and 330-c, associated with the active duration 315 of the DRX cycle 310) or monitor LP-WUS monitoring occasions 330 associated with the second type of LP-WUS (e.g., LP-WUS monitoring occasion 330-b, associated with the PDCCH monitoring occasions 320 outside of the active duration 315). In some cases, a network entity 105 may determine and configure which type of LP-WUS the UE 115 will monitor based on signaling for the UE 115, a channel quality between the network entity 105 and the UE 115, or other factors. In one or more of these cases described herein, the LP-WUS monitoring occasions 330 for the second type of LP-WUS may be inside the active duration 315 or outside the active duration 315 (e.g., according to the LP-WUS monitoring configuration). Additionally, or alternatively, some of these cases (e.g., the second case and the third case) may utilize both types of LP-WUSs.

In some cases, the LP-WUS monitoring occasion 330-a may be an LP-WUS monitoring occasion 330 for the first type of LP-WUS (e.g., for DRX based control channel monitoring, to replace DCP functionality). In some cases, the DRX cycle 310 may begin at a time 335-a, which may be the beginning of a subframe. Reception of an LP-WUS (e.g., of the first type) at the LP-WUS monitoring occasion 330-a may trigger a start of the active duration 315 (e.g., a start of the drx-OnDuration, the drx-OnDurationTimer). In some cases, the LP-WUS monitoring occasion 330-a may occur the time delay 345 (e.g., lp-wus-offset) before the beginning of the active duration 315. If an LP-WUS is received during the LP-WUS monitoring occasion 330-a, the UE 115 may wake up a main radio of the UE 115 during the time delay 345 and perform PDCCH monitoring during the active duration 315.

Additionally, based on receiving the LP-WUS during the LP-WUS monitoring occasion 330-a, the UE 115 may begin (e.g., at or after time 335-a) performing one or more operations based on control bits in the LP-WUS. For example, the UE 115 may perform the one or more operations after reception of the LP-WUS in the LP-WUS monitoring occasion 330-a and before, during, or after the active duration 315 associated with the LP-WUS. In some cases, the LP-WUS monitoring occasion 330-c may be associated with an active duration 315 of a next DRX cycle after the DRX cycle 310.

In some cases, the UE 115 may monitor for one or more LP-WUS of the second type in the one or more LP-WUS monitoring occasions 330 that are not associated with the active duration 315 of the DRX cycle 310 (e.g., LP-WUS triggered monitoring). For example, the UE 115 may receive an LP-WUS while monitoring the LP-WUS monitoring occasion 330-b. The PDCCH monitoring occasion 320 may be associated with the LP-WUS monitoring occasion 330-b, and may begin after a time offset 350 (e.g., a z-offset) from the end of the LP-WUS monitoring occasion 330-b. In some cases, the UE 115 may activate a main radio of the UE 115 during the time offset 350 to be able to perform PDCCH monitoring during the PDCCH monitoring occasion 320. In some cases, the UE 115 may also begin performing one or more operations indicated by the LP-WUS at time 335-b. For example, the UE 115 may perform the one or more operations after the LP-WUS monitoring occasion 330-b and before, during, or after the PDCCH monitoring occasions 320.

Both types of LP-WUS may indicate a same quantity of control bits using the same low power waveform (e.g., as described with respect to FIG. 2). Indicating the operations (e.g., functions) for the UE 115 to perform via either type of LP-WUS (e.g., in addition to switching on the main radio and PDCCH monitoring) may be advantageous to avoid signaling overhead and reduce power usage at the UE 115. However, both types of LP-WUS may have a limited payload (e.g., a limited quantity of control or information bits, up to eight control bits) due to the low power waveform. Additionally, useful operations for the UE 115 to perform before, during, or after the active duration 315 may be different from useful operations for the UE 115 to perform before, during, or after additional PDCCH monitoring occasions 320 (e.g., outside active duration). Thus, a total quantity of operations to indicate to the UE 115 for both types of LP-WUS may exceed the capacity of LP-WUS payload. Thus, techniques described herein may include one or more schemes to use the control bits of the LP-WUS to indicate the one or more operations for the UE 115 to perform.

The one or more operations performed before, during, or after an active duration 315 may be the same or different from the one or more operations performed before, during, or after the PDCCH monitoring occasion 320. For example, the one or more operations performed before, during, or after the active duration 315 (e.g., as indicated by the first type of LP-WUS) may include maintaining an inactivity timer associated with the DRX cycle 310 deactivated after reception of a control channel message (e.g., not starting a drx-InactivityTimer after receiving a control channel message during an associated active duration 315, which may be useful when a network entity 105 requests the UE 115 to transmit SRS or a CSI report during the active duration 315, which may be indicated in a control channel message received in a different PDCCH monitoring occasion 320 or active duration 315), changing or activating/deactivating a TCI state (e.g., changing a receive beam) associated with control channel monitoring, or monitoring for WUSs (e.g., LP-WUSs) using the low power radio of the UE 115 (e.g., instead of monitoring for control channel messages using the main radio), deactivating the DRX cycle, deactivate the use of the first type of LP-WUS and activate the use of the second type of LP-WUS, activating or deactivating LP-WUS-triggered control channel monitoring, skipping monitoring of one or more control channel monitoring occasions (e.g., extending PDCCH skipping, issuing a PDCCH skipping command similar to that of DCI messaging), switching an SSSG associated with the UE 115, activating communications via an SCell (e.g., waking up one or more SCells, similar to an SCell dormancy indication of DCP), activating communications via a frequency range, or any combination thereof. The one or more operations may also include one or more other operations indicated to the UE 115 via control signaling. Additionally, one or more of the operations described herein may be indicated by both the first type of LP-WUS and the second type of LP-WUS.

The one or more operations performed before, during, or after the PDCCH monitoring occasion 320 (e.g., as indicated by the second type of LP-WUS) may include skipping monitoring of one or more WUS monitoring occasions (e.g., skipping the next X LP-WUS monitoring occasions 330, where X is a positive integer), beginning monitoring for control channel messages a time offset 350 after the LP-WUS is received (e.g., start triggered PDCCH monitoring a duration (e.g., a quantity of milliseconds) after LP-WUS monitoring occasion 330), waking up the main radio of the UE 115 to transmit SRS and deactivating the main radio, activating the main radio to an alertness level (e.g., low, medium, or high alertness level), transmitting an SRS using the main radio of the UE 115, transmitting CSI report using the main radio of the UE 115, monitoring a WUS monitoring occasion (e.g., a LP-WUS monitoring occasion 330) using a low power radio of the UE, deactivating the main radio, changing the LP-WUS monitoring configuration of the UE 115, activating/deactivating LP-WUS monitoring configuration of the UE 115, activating/deactivating C-DRX operation, changing C-DRX configuration, activating or deactivating DCP, or any combination thereof. The one or more operations may also include one or more operations indicated to the UE 115 by control signaling. Further, one or more of the operations described herein may be indicated by both the first type of LP-WUS and the second type of LP-WUS.

In some cases, the control bits of each LP-WUS may indicate the one or more operations via a bitmap format (e.g., the bitmap format 280 of FIG. 2), a codepoint format (e.g., the codepoint format 285 of FIG. 2), or both. A bitmap format may be a format where each bit indicates whether or not (e.g., via values “1” and “0”, for example) to perform a corresponding operation. For example, if the LP-WUS includes N control bits (e.g., where N is a positive integer), the bitmap format may assign each of the N bits to one or more operations (e.g., as shown in Table 1 for the example where N=3). For example, if a first control bit of the N control bits is set to “1,” then the UE 115 may perform operation A, but if the first control bit is set to “0,” the UE may not perform operation A. Additionally, if a second control bit of the N control bits is set to “1,” then the UE 115 may perform operations B and C, but if the second control bit is set to “0,” the UE 115 may not perform operations B and C, and so forth.

TABLE 1

| Operation | A | B and C | D |
|---|---|---|---|
| Bit | First | Second | Third |

Thus, in total, using N bits in an LP-WUS, the LP-WUS may request that the UE 115 perform up to N sets of operations using the bitmap format. In some cases, the operations corresponding to each control bit may be configured by a network entity 105, or defined in one or more standards documents.

The codepoint format may be a format were a codepoint value of the bits (e.g., a binary value of multiple control bits) may indicate that the UE 115 perform one or more operations. For example, if the LP-WUS carries N control bit, a table (e.g., such as Table 2 for the example where N=3) may include 2^{N} rows where each row may include a codepoint value of the N control bits and one or more functions for the UE 115 to perform if the N control bits in a received LP-WUS have the corresponding codepoint value. For example, if N=3 and the three control bits of the LP-WUS have the codepoint value of “000,” the UE 115 may perform the operations A and B, but if the three control bits of the LP-WUS have the codepoint value “100,” the UE 115 may perform operation D. Additionally, or alternatively, one or more codepoint values of the control bits may indicate no operations (e.g., null, requesting that the UE 115 does not perform any additional operations).

TABLE 2

| Codepoint Value | Operation(s) |
|---|---|
| 000 | A and B |
| 001 | B |
| 010 | Null (e.g., no operations) |
| 011 | C |
| 100 | D |
| 101 | E and F |
| 110 | A and B and F |
| 111 | G |

Thus, in total, using N bits in an LP-WUS, the LP-WUS may request that the UE 115 perform one out of 2^{N} sets of operations using the codepoint format. In some cases, the operations corresponding to each codepoint value may be configured by a network entity 105, or defined in one or more standards documents.

According to techniques described herein, the one or more operations mapped to the control bits (e.g., either using the bitmap format or the codepoint format) may vary for different types of LP-WUS. For example, in the bitmap format, each bit may indicate whether the UE 115 is to perform one or more corresponding operations, where the one or more corresponding operations may depend on the type of the LP-WUS. In the codepoint format, each codepoint value may indicate that the UE 115 is to perform one or more corresponding operations, where the one or more corresponding operations may depend on the type of the LP-WUS. Thus, a same value of the control bits in the LP-WUS may cause the UE 115 to perform different operations based on the type of the LP-WUS.

To interpret the control bits of an LP-WUS correctly, the UE 115 may determine the type of the LP-WUS. In some cases, the UE 115 may determine the type of an LP-WUS based on the resources in which LP-WUS is transmitted and received (e.g., the resources of an LP-WUS monitoring occasion 330), a first control bit of the one or more control bits indicated by the LP-WUS, whether a control channel monitoring occasion (e.g., either a PDCCH monitoring occasion 320 or an active duration 315) associated with the LP-WUS is within an active duration of a DRX cycle 310, or any combination thereof. For example, a network entity 105 may explicitly indicate to the UE 115 which LP-WUS monitoring occasions 330 of the LP-WUS configuration are for the first type of LP-WUS and the second type of LP-WUS. The network entity 105 may indicate such information in the LP-WUS monitoring configuration, in separate control signaling, or both. Additionally, or alternatively, the UE 115 may implicitly infer that an LP-WUS monitoring occasion 330 that is configured a time delay 345 before the start of a potential active duration 315 is for a first type of LP-WUS, and that other LP-WUS monitoring occasions 330 are for the second type of LP-WUS. Additionally, or alternatively, the network entity 105 may set a value of one or more first control bits of the LP-WUS to indicate the type of the LP-WUS.

Additionally, or alternatively, one or more control bits indicated by the LP-WUS may indicate whether the remaining control bits indicate one or more operations for the first type of LP-WUS or the second type of LP-WUS (e.g., a mapping of the remaining one or more control bits to one or more operations, how the UE 115 is to interpret the remaining one or more control bits). For example, a first control bit indicated by the LP-WUS may indicate the type of the LP-WUS, and the UE 115 may interpret the remaining one or more control bits based on the first control bit. Thus, a single value of the one or more remaining control bits of the LP-WUS (e.g., either in the bitmap format or the codepoint format) may indicate different operations for the UE 115 to perform depending on a value of the first control bit of the LP-WUS.

Additionally, or alternatively, the control bits in an LP-WUS may be of the bitmap format or the codepoint format based on the type of the LP-WUS. For example, the control bits of LP-WUSs of the first type may map to one or more operations according to the bitmap format, and control bits of LP-WUSs of the second type may map to one or more operations according to the codepoint format. Thus, the format by which the UE 115 interprets the control bits of the LP-WUS may depend on the type of the LP-WUS containing the control bits. In some cases, one or more control bits of the LP-WUS may indicate whether the remaining controls bits of the LP-WUS are of the bitmap format or the codepoint format, which may correspond to the type of the LP-WUS (e.g., may be the same control bit that indicates the type of the LP-WUS). Thus, one value of the control bits of an LP-WUS may be mapped to one or more different operations according to different mapping formats (e.g., bitmap and codepoint) based on a type of the LP-WUS, a first one or more control bits of the LP-WUS, or both.

Based on the techniques described herein, a UE 115 may perform one or more additional operations (e.g., in addition to PDCCH monitoring) based on control bits and a type of a received LP-WUS. Accordingly, the UE 115 may experience less latency and power usage based on receiving less signaling via the main radio. Additionally, or alternatively, the UE 115 may utilize wireless communication resources more efficiently by avoiding additional signaling to indicate the one or more operations to perform.

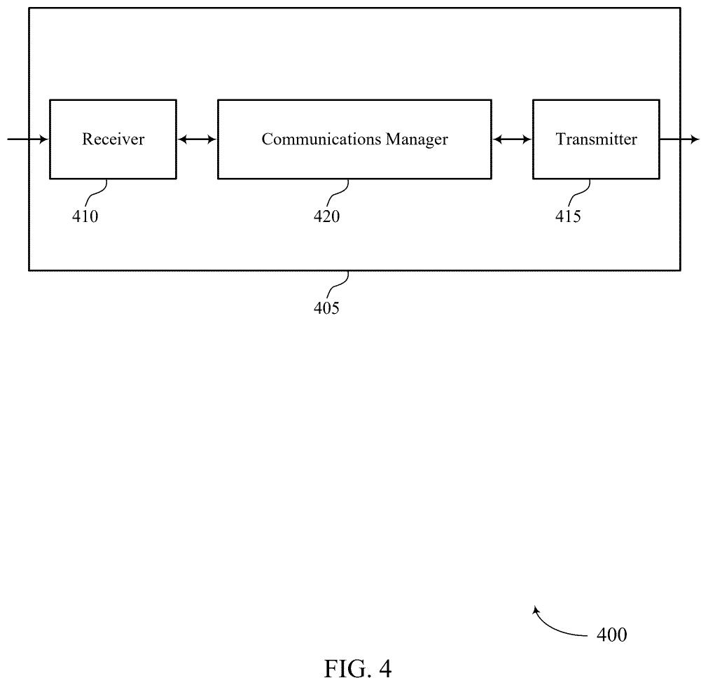

FIG. 4 shows a block diagram 400 of a device 405 that supports LP-WUS control bit utilization in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to LP-WUS control bit utilization). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to LP-WUS control bit utilization). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of LP-WUS control bit utilization as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a WUS corresponding to a control channel monitoring occasion for the UE and indicating control bits via a low power waveform. The communications manager 420 is capable of, configured to, or operable to support a means for monitoring for a control channel message during the control channel monitoring occasion based on the WUS. The communications manager 420 is capable of, configured to, or operable to support a means for performing an operation indicated by the control bits according to a type of the WUS.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption and more efficient utilization of communication resources. For example, a UE 115 implementing the techniques herein may activate a main radio less often to receive control signaling and may receive indications via LP-WUSs, which may reduce power usage at the UE 115 and reduce signaling overhead for receiving such indications.

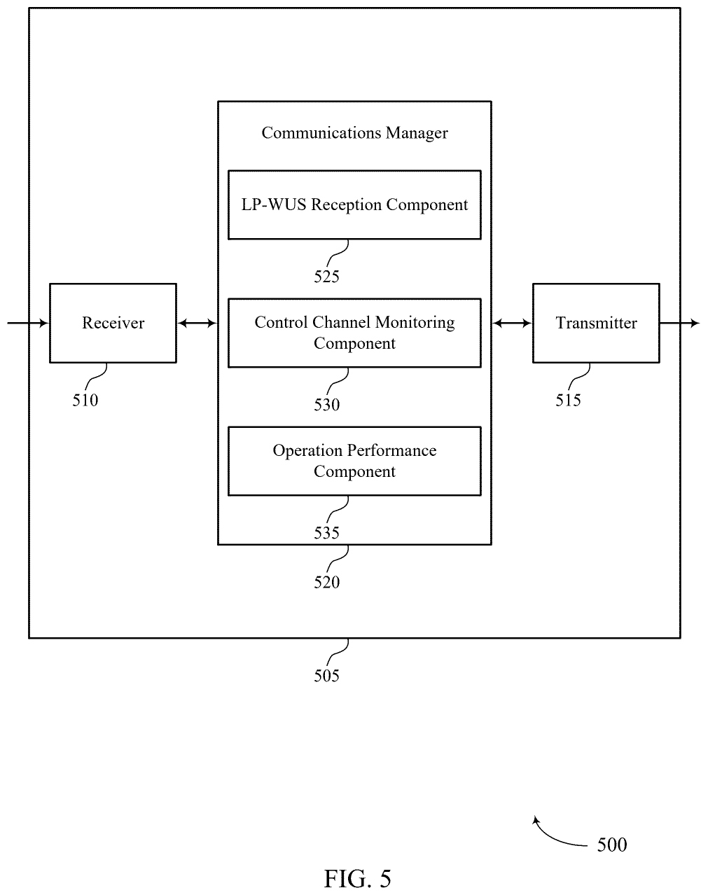

FIG. 5 shows a block diagram 500 of a device 505 that supports LP-WUS control bit utilization in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to LP-WUS control bit utilization). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to LP-WUS control bit utilization). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of LP-WUS control bit utilization as described herein. For example, the communications manager 520 may include an LP-WUS reception component 525, a control channel monitoring component 530, an operation performance component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The LP-WUS reception component 525 is capable of, configured to, or operable to support a means for receiving a WUS corresponding to a control channel monitoring occasion for the UE and indicating control bits via a low power waveform. The control channel monitoring component 530 is capable of, configured to, or operable to support a means for monitoring for a control channel message during the control channel monitoring occasion based on the WUS. The operation performance component 535 is capable of, configured to, or operable to support a means for performing an operation indicated by the control bits according to a type of the WUS.

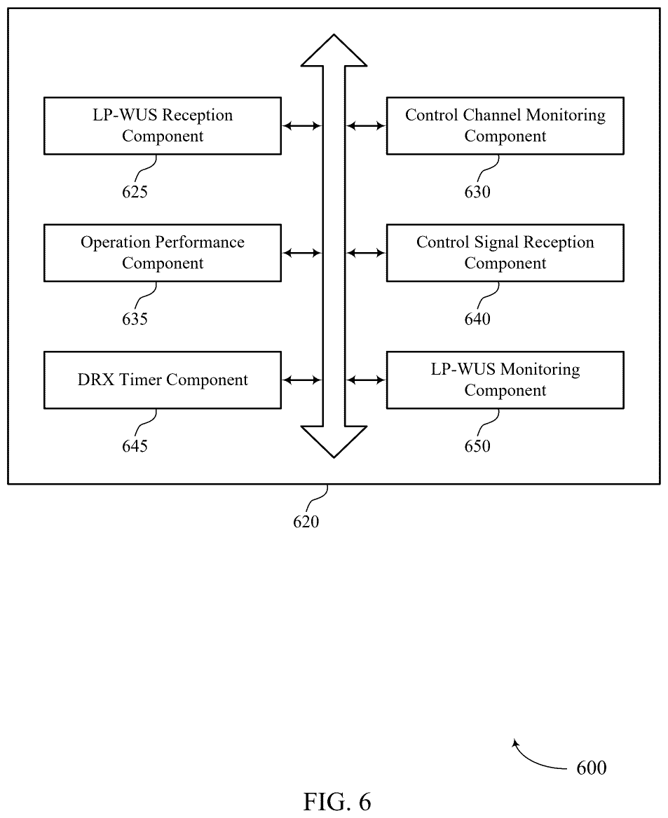

FIG. 6 shows a block diagram 600 of a communications manager 620 that supports LP-WUS control bit utilization in accordance with one or more aspects of the present disclosure. The communications manager 620 may be an example of aspects of a communications manager 420, a communications manager 520, or both, as described herein. The communications manager 620, or various components thereof, may be an example of means for performing various aspects of LP-WUS control bit utilization as described herein. For example, the communications manager 620 may include an LP-WUS reception component 625, a control channel monitoring component 630, an operation performance component 635, a control signal reception component 640, a DRX timer component 645, an LP-WUS monitoring component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The LP-WUS reception component 625 is capable of, configured to, or operable to support a means for receiving a WUS corresponding to a control channel monitoring occasion for the UE and indicating control bits via a low power waveform. The control channel monitoring component 630 is capable of, configured to, or operable to support a means for monitoring for a control channel message during the control channel monitoring occasion based on the WUS. The operation performance component 635 is capable of, configured to, or operable to support a means for performing an operation indicated by the control bits according to a type of the WUS.

In some examples, the type of the WUS is based on whether the control channel monitoring occasion occurs within an active duration of a DRX cycle.

In some examples, a value of a first control bit of the control bits indicates the type of the WUS.

In some examples, the operation is performed based on one or more remaining control bits of the control bits that exclude the first control bit. In some examples, the one or more remaining control bits indicate the operation based on the value of the first control bit.

In some examples, the control bits include a bitmap format to indicate the operation, where a value of a control bit of the control bits indicates to perform the operation. In some examples, the control bits include a codepoint format to indicate the operation, where a codepoint value of one or more of the control bits indicates to perform the operation.

In some examples, the operation is indicated by the bitmap format of the control bits or the codepoint format of the control bits based on the type of the WUS.

In some examples, a value of a first control bit of the control bits indicate whether one or more remaining control bits of the control bits excluding the first control bit include the bitmap format or the codepoint format to indicate the operation.

In some examples, a resource in which the WUS is received indicates the type of the WUS.

In some examples, the control signal reception component 640 is capable of, configured to, or operable to support a means for receiving control signaling that indicates one or more first WUS monitoring occasions corresponding to WUSs of a first type and indicates one or more second WUS monitoring occasions corresponding to WUSs of a second type, where the WUS is received based on the one or more first WUS monitoring occasions or the one or more second WUS monitoring occasions.

In some examples, the low power waveform includes an on-off-keying (OOK) waveform received by a low power radio of the UE. In some examples, the OOK waveform includes a sequence of high amplitude durations, low amplitude durations, or both, corresponding to respective high values, low values, or both, of the control bits.

In some examples, the type of the WUS is associated with the control channel monitoring occasion occurring within an active duration of a DRX cycle. In some examples, the operation includes one or more of maintaining an inactivity timer deactivated after reception of the control channel message, changing a transmission configuration indicator state associated with control channel monitoring, monitoring for WUSs using a low power radio of the UE, deactivating the DRX cycle, activating WUS-triggered control channel monitoring, skipping monitoring of one or more control channel monitoring occasions, switching a search space set group associated with the UE, and activating communications via a secondary cell, a frequency range, or both.

In some examples, the DRX timer component 645 is capable of, configured to, or operable to support a means for initiating an on duration timer associated with a DRX cycle based on the type of the WUS being associated with the control channel monitoring occasion being within an active duration of the DRX cycle.

In some examples, the LP-WUS monitoring component 650 is capable of, configured to, or operable to support a means for monitoring for the WUS outside of an active duration of a DRX cycle according to a WUS monitoring configuration, where the WUS is received based on monitoring for the WUS.

In some examples, the LP-WUS monitoring component 650 is capable of, configured to, or operable to support a means for monitoring for the WUS within an active duration of a DRX cycle according to a WUS monitoring configuration, where the WUS is received based on monitoring for the WUS.

In some examples, the type of the WUS is associated with the control channel monitoring occasion not occurring within an active duration of a DRX cycle. In some examples, the operation includes one or more of skipping monitoring of one or more WUS monitoring occasions, beginning the monitoring for the control channel message a time interval after the WUS is received, activating a main radio of the UE to an alertness level, transmitting a sounding reference signal using the main radio of the UE, transmitting channel state information using the main radio of the UE, monitoring a WUS monitoring occasion using a low power radio of the UE, deactivating the main radio, and changing a WUS monitoring configuration of the UE.

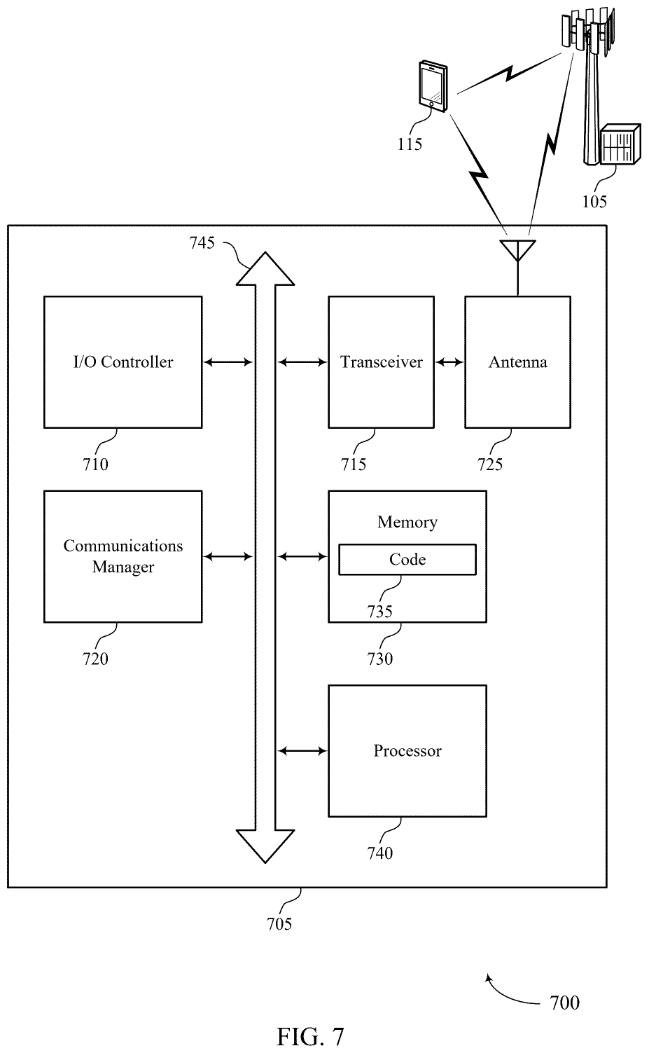

FIG. 7 shows a diagram of a system 700 including a device 705 that supports LP-WUS control bit utilization in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting LP-WUS control bit utilization). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a WUS corresponding to a control channel monitoring occasion for the UE and indicating control bits via a low power waveform. The communications manager 720 is capable of, configured to, or operable to support a means for monitoring for a control channel message during the control channel monitoring occasion based on the WUS. The communications manager 720 is capable of, configured to, or operable to support a means for performing an operation indicated by the control bits according to a type of the WUS.

By including or configuring the communications manager 720 in accordance with examples as described herein, the device 705 may support techniques for reduced latency, longer battery life, and more efficient utilization of communication resources. For example, a UE 115 implementing the techniques herein may activate a main radio less often to receive control signaling and may receive indications via LP-WUSs, which may reduce power usage at the UE 115 and reduce signaling overhead for receiving such indications. Additionally, the UE 115 may receive a WUS that also indicates operations to perform at the UE 115, reducing latency associated with receiving separate signaling to indicate the operations.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of LP-WUS control bit utilization as described herein, or the at least one processor 740 and the at least one memory 730 may be otherwise configured to, individually or collectively, perform or support such operations.

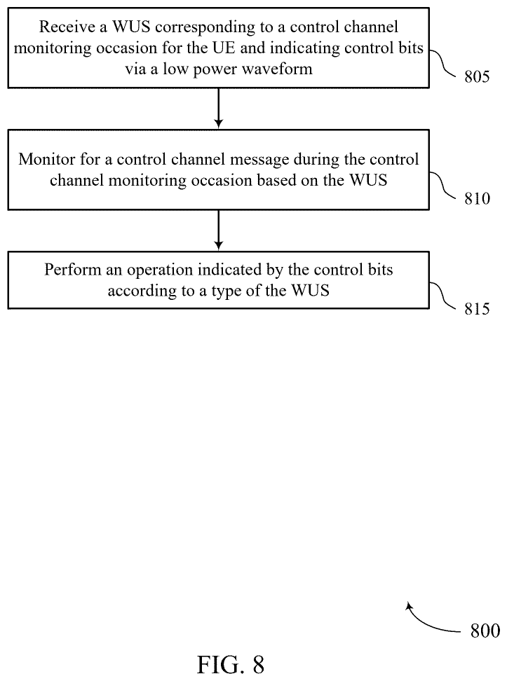

FIG. 8 shows a flowchart illustrating a method 800 that supports LP-WUS control bit utilization in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving a WUS corresponding to a control channel monitoring occasion for the UE and indicating control bits via a low power waveform. The operations of 805 may be performed in accordance with examples as disclosed herein. In some examples, aspects of the operations of 805 may be performed by an LP-WUS reception component 625 as described with reference to FIG. 6.

At 810, the method may include monitoring for a control channel message during the control channel monitoring occasion based on the WUS. The operations of 810 may be performed in accordance with examples as disclosed herein. In some examples, aspects of the operations of 810 may be performed by a control channel monitoring component 630 as described with reference to FIG. 6.

At 815, the method may include performing an operation indicated by the control bits according to a type of the WUS. The operations of 815 may be performed in accordance with examples as disclosed herein. In some examples, aspects of the operations of 815 may be performed by an operation performance component 635 as described with reference to FIG. 6.

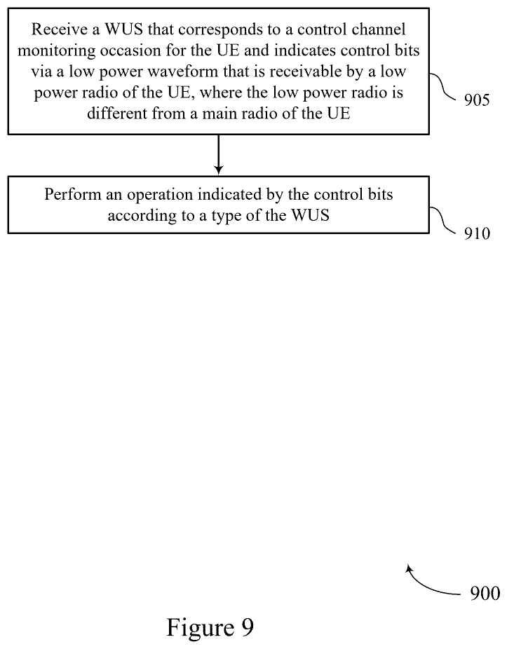

FIG. 9 shows an example of a method 900 that supports low power wake up signal control bit utilization. Operations of the method 900 may be performed by a UE or its components (such as using a processing system configured to cause the UE 115 to perform one or more of the operations) as described herein.

At 905, the method may include performing an operation indicated by the control bits according to a type of the wake up signal. In some examples, aspects of the operations of 905 may be performed by an operation performance component 535.

At 910, the method may include receiving a wake up signal that corresponds to a control channel monitoring occasion for the UE and indicates control bits via a low power waveform that is receivable by a low power radio of the UE, where the low power radio is different from a main radio of the UE. In some examples, aspects of the operations of 910 may be performed by an LP-WUS reception component 525.

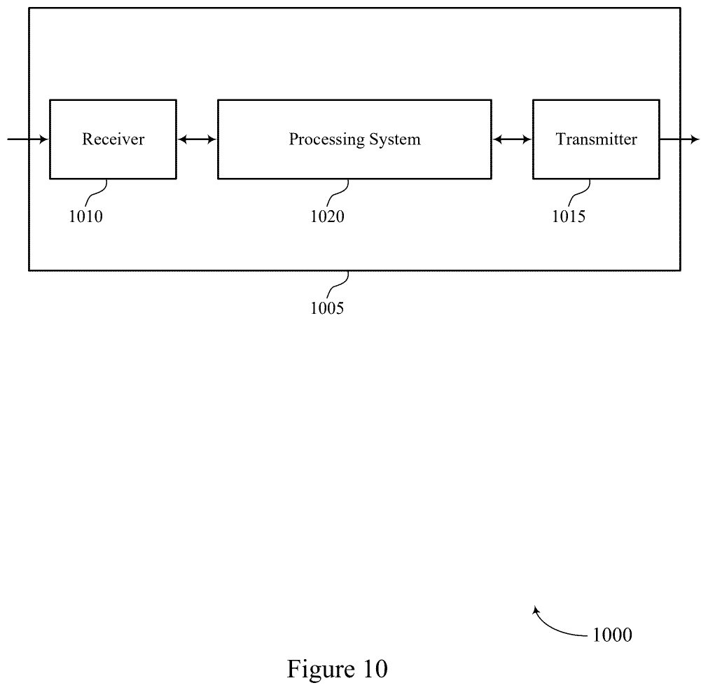

FIG. 10 shows a block diagram 1000 of a device 1005 that supports low power wake up signal control bit utilization in accordance with one or more aspects of the present disclosure. The device 1005 may be an example of aspects of a network entity 105 as described herein. The device 1005 may include a receiver 1010, a transmitter 1015, and a processing system 1020. The device 1005, or one or more components of the device 1005 (e.g., the receiver 1010, the transmitter 1015, the processing system 1020), may include at least one processor, which may be coupled with at least one memory, to, individually or collectively, support or enable the described techniques. Each of these components may be in communication with one another (e.g., via one or more buses).

The processing system 1020, the receiver 1010, the transmitter 1015, or various combinations or components thereof may be examples of means for performing various aspects of low power wake up signal control bit utilization as described herein. For example, the processing system 1020, the receiver 1010, the transmitter 1015, or various combinations or components thereof may be capable of performing one or more of the functions described herein.

In some examples, the processing system 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the processing system 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the processing system 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

The processing system 1020 may support wireless communication in accordance with examples as disclosed herein. For example, the processing system 1020 is capable of, configured to, or operable to support a means for output a wake up signaling that corresponds to a control channel monitoring occasion for a UE and indicates control bits via a low power waveform receivable by a low power radio that is different from a main radio, where the control bits indicate one or more operations to be performed at the UE according to a type of the wake up signal. The processing system 1020 is capable of, configured to, or operable to support a means for communicating with the UE based on the one or more operations indicated by the control bits according to the type of the wake up signal.

By including or configuring the processing system 1020 in accordance with examples as described herein, the device 1005 (e.g., at least one processor controlling or otherwise coupled with the receiver 1010, the transmitter 1015, the processing system 1020, or a combination thereof) may support techniques for reduced power consumption and more efficient utilization of communication resources at a network entity.

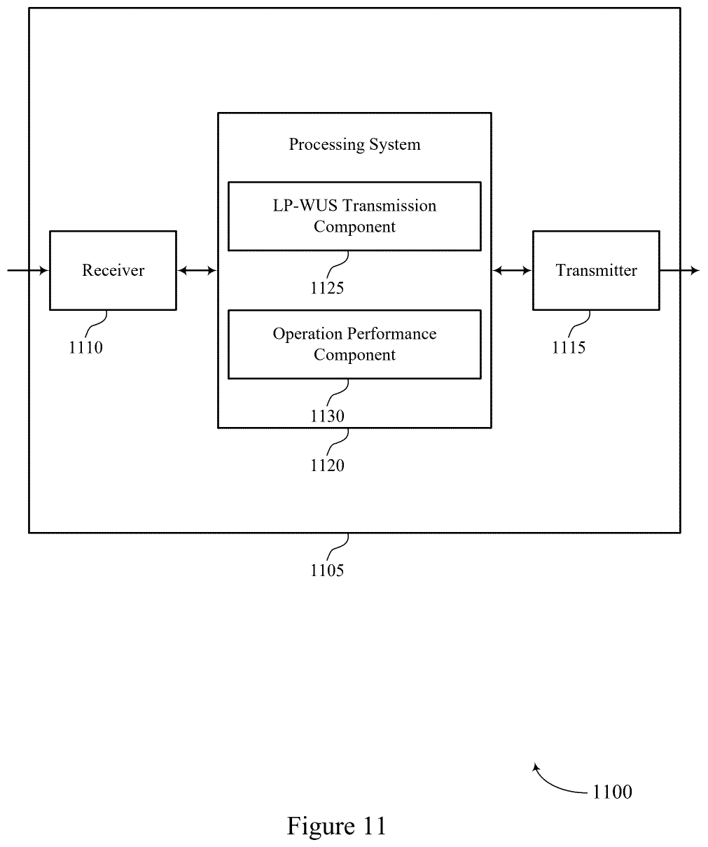

FIG. 11 shows a block diagram 1100 of a device 1105 that supports low power wake up signal control bit utilization. The device 1105 may be an example of aspects of a device 1005 or a network entity 105 as described herein. The device 1105 may include a receiver 1110, a transmitter 1115, and a processing system 1120. The device 1105, or one of more components of the device 1105 (e.g., the receiver 1110, the transmitter 1115, the processing system 1120), may include at least one processor, which may be coupled with at least one memory, to support the described techniques. Each of these components may be in communication with one another (e.g., via one or more buses).

The device 1105, or various components thereof, may be an example of means for performing various aspects of low power wake up signal control bit utilization as described herein. For example, the processing system 1120 may include an LP-WUS transmission component 1125 an operation performance component 1130, or any combination thereof. The processing system 1120 may be an example of aspects of a processing system 1020 as described herein. In some examples, the processing system 1120, or various components thereof, may be configured to perform various operations (e.g., receiving, obtaining, monitoring, outputting, transmitting) using or otherwise in cooperation with the receiver 1110, the transmitter 1115, or both. For example, the processing system 1120 may receive information from the receiver 1110, send information to the transmitter 1115, or be integrated in combination with the receiver 1110, the transmitter 1115, or both to obtain information, output information, or perform various other operations as described herein.

The processing system 1120 may support wireless communication in accordance with examples as disclosed herein. The LP-WUS transmission component 1125 is capable of, configured to, or operable to support a means for output a wake up signal that corresponds to a control channel monitoring occasion for a UE and indicates control bits via a low power waveform receivable by a low power radio that is different from a main radio, where the control bits indicate one or more operations to be performed at the UE according to a type of the wake up signal. The operation performance component 1130 is capable of, configured to, or operable to support a means for communicating with the UE based on the one or more operations indicated by the control bits according to the type of the wake up signal.

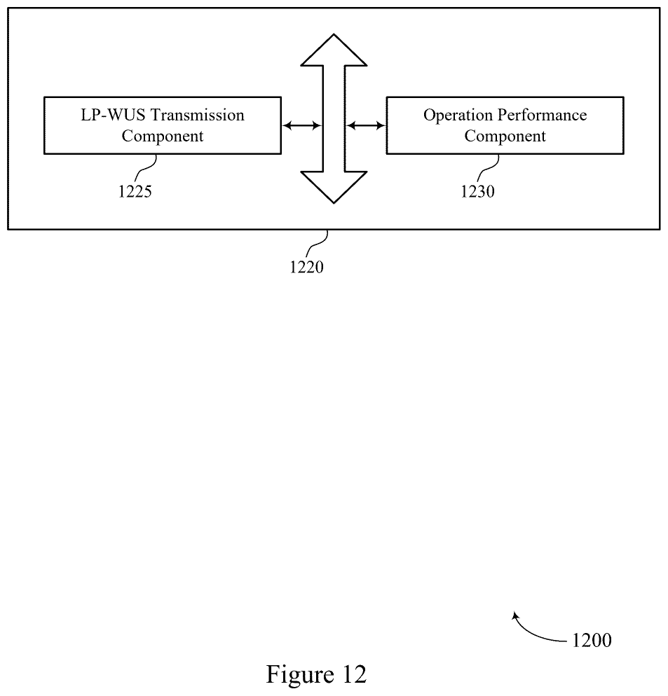

FIG. 12 shows an example 1200 of a processing system 1220 that supports low power wake up signal control bit utilization. A processing system 1220 may be an example of a processing system of a network entity 105 and may include an LP-WUS transmission component 1225 an operation performance component 1230, or any combination thereof. A processing system 1020, or various component thereof, may be an example of means for performing (such as a means for causing a network entity 105 to perform) various techniques described herein.

The LP-WUS transmission component 1225 may be configured to cause the network entity 105 to output a wake up signal that corresponds to a control channel monitoring occasion for a UE and indicates control bits via a low power waveform receivable by a low power radio that is different from a main radio, where the control bits indicate one or more operations to be performed at the UE according to a type of the wake up signal. The operation performance component 1230 may be configured to cause the network entity 105 to communicate with the UE based on the one or more operations indicated by the control bits according to the type of the wake up signal.

In some examples, the type of the wake up signal is based on whether the control channel monitoring occasion occurs within an active duration of a discontinuous reception cycle.

In some examples, a value of a first control bit of the control bits indicates the type of the wake up signal, the one or more operations are performed based on one or more remaining control bits of the control bits that exclude the first control bit, and the one or more remaining control bits indicate the one or more operations based on the value of the first control bit.

In some examples, the control bits include a bitmap format to indicate the one or more operations, a value of a control bit of the control bits indicates to perform the one or more operations, or the control bits include a codepoint format to indicate the one or more operations, a codepoint value of one or more of the control bits indicates to perform the one or more operations.

In some examples, the one or more operations are indicated by the bitmap format of the control bits or the codepoint format of the control bits based on the type of the wake up signal.

A processing system 1220 may include or be an example of one or more chips, SoCs, chipsets, packages, components, or devices that individually or collectively constitute or include a processing system. A processing system 1220 may interface with other components of a network entity 105. For example, operations described with reference to a processing system 1220, or various components thereof, may be performed by or with other such components, including a receiver, a transmitter, a transceiver, a modem, a user interface, a modulator/demodulator, an encoder/decoder, or any combination thereof (such as of the processing system 1220, coupled with the processing system 1220, of a network entity 105). Operations described herein with reference to the processing system 1220, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 1220 for operation in a processing system 1220 as described herein, the processing system 1220 may support techniques for reduced latency, reduced power consumption, and more efficient utilization of communication resources at a network entity.

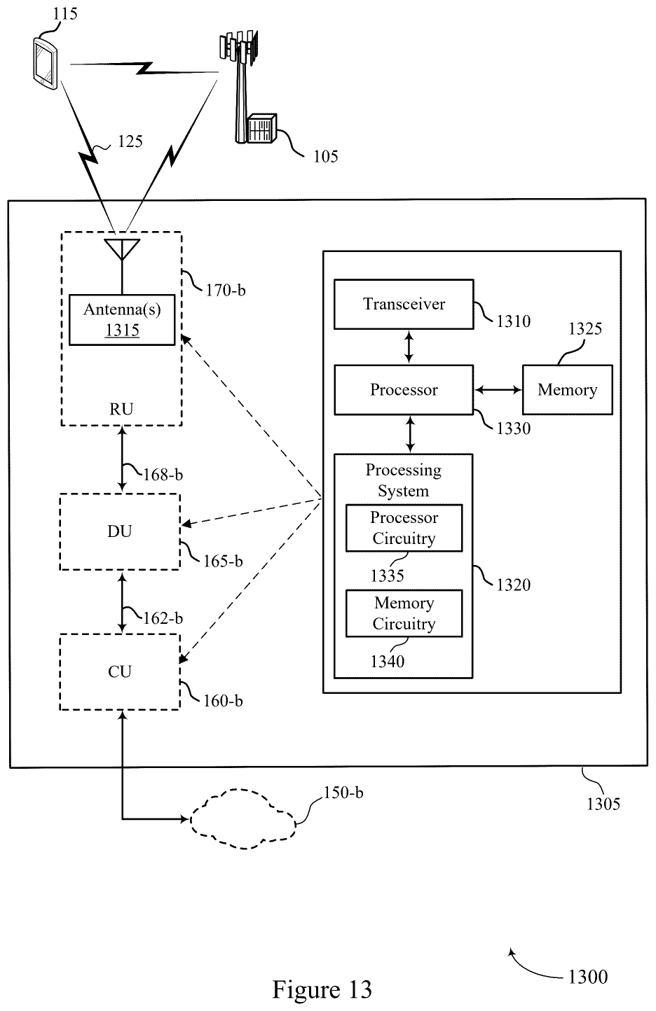

FIG. 13 shows an example of a system 1300 including a device 1305 that supports low power wake up signal control bit utilization. The device 1305 may be an example of or include components of a device 1005, a device 1105, or a network entity 105 as described herein. The device 1305 may communicate (such as via one or more wired interfaces or one or more wireless interfaces) with other network devices or network equipment such as a core network 150-b, other network entities 105, UEs 115, or any combination thereof. The device 1305 may include components for transmitting and receiving communication, which may include a processing system 1320, a transceiver 1310, antenna(s) 1315, a memory 1325, and a processor 1330. Components of the device 1305 may be coupled (such as operatively, communicatively, functionally, electronically, electrically, in electronic communication) via one or more interfaces.

The transceiver 1310 may communicate bi-directionally with another transceiver via wired or wireless links, and may support transmission operations, reception operations, or both, as described herein. The transceiver 1310 may include a modem to modulate and demodulate signals, to provide the modulated signals for transmission (such as via antenna(s) 1315, via a wired interface), and to demodulate received signals (such as received via antenna(s) 1315, received via a wired interface). The transceiver 1310 may be operable to support communication via one or more communication links (such as a communication link 135, a backhaul link (e.g., as described with respect to FIG. 1), a midhaul link 162-b, fronthaul link 168-b).

The processor 1330 may be a general-purpose processing component that supports various operations (such as applications) of the device 1305. The memory 1325 may be a general-purpose storage component that stores code executable by the processor 1330. Such code may include instructions that, when executed by the processor 1330, cause the device 1305 to perform various functions (such as to support an application of the device 1305).

For examples in which the device 1305 is a network entity 105 in a disaggregated architecture, one or more components of the device 1305 may be located at one or more of a CU 160-b, a DU 165-b, or an RU 170-b, one or more of which may include aspects of the processing system 1320, the processor 1330, the memory 1325, or the transceiver 1310. Functions of the device 1305 may be performed at different components or an operation may be divided between different components (such as different functions being supported by aspects of the CU 160-b, the DU 165-b, or the RU 170-b, the transceiver 1310, the processor 1330, the memory 1325, the processing system 1320, or any combination thereof). For example, the processing system 1320 may be a component of one or more of the CU 160-b, the DU 165-b, or the RU 170-b. In some examples, interfaces between components of device 1305 (such as CU 160-b, DU 165-b, RU 170-b) may support communication at a protocol layer or between protocol layers of a protocol stack.

In some examples, the processing system 1320 may manage aspects of communication with the core network 150-b (such as via a backhaul link). For example, the processing system 1320 may manage the transfer of data communication for UEs 115 with a gateway of the core network 150-b. In some examples, the processing system 1320 may manage communication with one or more other network entities 105 and may include a controller or scheduler for controlling communication with UEs 115 (such as in cooperation with the one or more other network entities 105). In some examples, the processing system 1320 may support an interface (such as X2 interface, Xn interface) to provide communication between network entities 105.

The processing system 1320 may be an example of a processing system of a network entity 105 or a processing system 1020. For example, the processing system 1320 may include processor circuitry 1335 and memory circuitry 1340 that stores code, and the processing system 1320 may be configured to cause the device 1305 to perform operations that support low power wake up signal control bit utilization. Although the processing system 1320 is illustrated as a separate component, which may involve a separate chip, chipset, or other module, in some implementations, one or more functions described with reference to the processing system 1320 may be supported by or performed by a transceiver 1310, antenna(s) 1315, a processor 1330, memory 1325, or any combination thereof, such that a processing system 1320 may include one or more of a transceiver 1310, antenna(s) 1315, a processor 1330, memory 1325, or any combination thereof. Further, processor circuitry 1335 and memory circuitry 1340 each may be implemented at the device 1305 in accordance with an aggregated architecture, or the processor circuitry 1335 and the memory circuitry 1340 may be implemented at one or more of a CU 160-b, a DU 165-b, or an RU 170-b in accordance with a disaggregated architecture.

By including or configuring the processing system 1320 for operation in the device 1305 as described herein, the processing system 1220 may support techniques for reduced latency, reduced power consumption, more efficient utilization of communication resources, and improved coordination between devices.

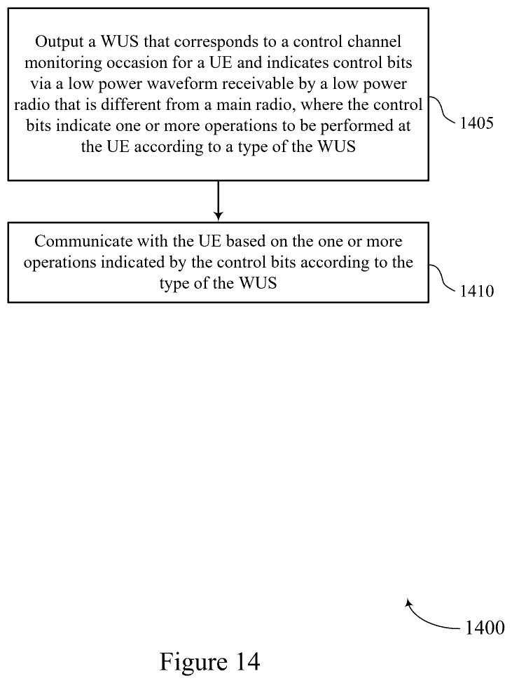

FIG. 14 shows an example of a method 1400 that supports low power wake up signal control bit utilization. Operations of the method 1400 may be performed by a network entity 105 or its components (such as using a processing system configured to cause the network entity to perform one or more operations) as described herein.

At 1405, the method may include output a wake up signal that corresponds to a control channel monitoring occasion for a UE and indicates control bits via a low power waveform receivable by a low power radio that is different from a main radio, where the control bits indicate one or more operations to be performed at the UE according to a type of the wake up signal. In some examples, aspects of the operations of 1405 may be performed by an LP-WUS transmission component 1125.

At 1410, the method may include communicating with the UE based on the one or more operations indicated by the control bits according to the type of the wake up signal. In some examples, aspects of the operations of 1410 may be performed by an operation performance component 1130.

The following provides an overview of aspects of the present disclosure:

Aspect 1: A method for wireless communications at a UE, comprising: receiving a WUS corresponding to a control channel monitoring occasion for the UE and indicating control bits via a low power waveform; monitoring for a control channel message during the control channel monitoring occasion based at least in part on the WUS; and performing an operation indicated by the control bits according to a type of the WUS.

Aspect 2: The method of aspect 1, wherein the type of the WUS is based at least in part on whether the control channel monitoring occasion occurs within an active duration of a DRX cycle.

Aspect 3: The method of any of aspects 1 through 2, wherein a value of a first control bit of the control bits indicates the type of the WUS.

Aspect 4: The method of aspect 3, wherein the operation is performed based at least in part on one or more remaining control bits of the control bits that exclude the first control bit, the one or more remaining control bits indicate the operation based at least in part on the value of the first control bit.

Aspect 5: The method of any of aspects 1 through 4, wherein one or more of the control bits comprise a bitmap format to indicate the operation, wherein a value of a control bit of the control bits indicates to perform the operation; and the control bits comprise a codepoint format to indicate the operation, wherein a codepoint value of one or more of the control bits indicates to perform the operation.

Aspect 6: The method of aspect 5, wherein the operation is indicated by the bitmap format of the control bits or the codepoint format of the control bits based at least in part on the type of the WUS.

Aspect 7: The method of any of aspects 5 through 6, wherein a value of a first control bit of the control bits indicate whether one or more remaining control bits of the control bits excluding the first control bit comprise the bitmap format or the codepoint format to indicate the operation.

Aspect 8: The method of any of aspects 1 through 7, wherein a resource in which the WUS is received indicates the type of the WUS.

Aspect 9: The method of any of aspects 1 through 8, further comprising: receiving control signaling that indicates one or more first WUS monitoring occasions corresponding to WUSs of a first type and indicates one or more second WUS monitoring occasions corresponding to WUSs of a second type, wherein the WUS is received based at least in part on the one or more first WUS monitoring occasions or the one or more second WUS monitoring occasions.

Aspect 10: The method of any of aspects 1 through 9, wherein the low power waveform comprises an OOK waveform received by a low power radio of the UE, the OOK waveform comprises a sequence of high amplitude durations, low amplitude durations, or both, corresponding to respective high values, low values, or both, of the control bits.

Aspect 11: The method of any of aspects 1 through 10, wherein the type of the WUS is associated with the control channel monitoring occasion occurring within an active duration of a DRX cycle, and the operation comprises one or more of maintaining an inactivity timer deactivated after reception of the control channel message, changing a transmission configuration indicator state associated with control channel monitoring, monitoring for WUSs using a low power radio of the UE, deactivating the DRX cycle, activating WUS-triggered control channel monitoring, skipping monitoring of one or more control channel monitoring occasions, switching a search space set group associated with the UE, and activating communications via a secondary cell, a frequency range, or both.

Aspect 12: The method of any of aspects 1 through 11, further comprising: initiating an on duration timer associated with a DRX cycle based at least in part on the type of the WUS being associated with the control channel monitoring occasion being within an active duration of the DRX cycle.

Aspect 13: The method of any of aspects 1 through 12, further comprising: monitoring for the WUS outside of an active duration of a DRX cycle according to a WUS monitoring configuration, wherein the WUS is received based at least in part on monitoring for the WUS.

Aspect 14: The method of any of aspects 1 through 13, further comprising: monitoring for the WUS within an active duration of a DRX cycle according to a WUS monitoring configuration, wherein the WUS is received based at least in part on monitoring for the WUS.

Aspect 15: The method of any of aspects 1 through 10 and 12 through 14, wherein the type of the WUS is associated with the control channel monitoring occasion not occurring within an active duration of a DRX cycle, and the operation comprises one or more of skipping monitoring of one or more WUS monitoring occasions, beginning the monitoring for the control channel message a time interval after the WUS is received, activating a main radio of the UE to an alertness level, transmitting a sounding reference signal using the main radio of the UE, transmitting channel state information using the main radio of the UE, monitoring a WUS monitoring occasion using a low power radio of the UE, deactivating the main radio, and changing a WUS monitoring configuration of the UE.

Aspect 16: A UE for wireless communications, comprising one or more memories storing processor-executable code, and one or more processors coupled with the one or more memories and individually or collectively operable to execute the code to cause the UE to perform a method of any of aspects 1 through 15.

Aspect 17: A UE for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

Aspect 19: A method for wireless communication at a UE, comprising: receiving a wake up signal that corresponds to a control channel monitoring occasion for the UE and indicates control bits via a low power waveform that is receivable by a low power radio of the UE, wherein the low power radio is different from a main radio of the UE; and performing an operation indicated by the control bits according to a type of the wake up signal.

Aspect 20: The method of aspect 19, wherein the type of the wake up signal is based at least in part on whether the control channel monitoring occasion occurs within an active duration of a discontinuous reception cycle.

Aspect 21: The method of any of aspects 19 through 20, wherein a value of a first control bit of the control bits indicates the type of the wake up signal.

Aspect 22: The method of aspect 21, wherein the operation is performed based at least in part on one or more remaining control bits of the control bits that exclude the first control bit, and the one or more remaining control bits indicate the operation based at least in part on the value of the first control bit.

Aspect 23: The method of any of aspects 19 through 22, wherein the control bits comprise a bitmap format to indicate the operation, a value of a control bit of the control bits indicates to perform the operation, or the control bits comprise a codepoint format to indicate the operation, and a codepoint value of one or more of the control bits indicates to perform the operation.

Aspect 24: The method of aspect 23, wherein the operation is indicated by the bitmap format of the control bits or the codepoint format of the control bits based at least in part on the type of the wake up signal.

Aspect 25: The method of any of aspects 23 through 24, wherein a value of a first control bit of the control bits indicates whether one or more remaining control bits of the control bits that exclude the first control bit comprise the bitmap format or the codepoint format to indicate the operation.

Aspect 26: The method of any of aspects 19 through 25, wherein a resource in which the wake up signal is received indicates the type of the wake up signal.

Aspect 27: The method of any of aspects 19 through 26, further comprising: receiving control signaling that indicates one or more first wake up signal monitoring occasions that corresponds to wake up signals of a first type and indicates one or more second wake up signal monitoring occasions that correspond to wake up signals of a second type, wherein the wake up signal is received based at least in part on the one or more first wake up signal monitoring occasions or the one or more second wake up signal monitoring occasions.

Aspect 28: The method of any of aspects 19 through 27, wherein the type of the wake up signal is associated with an active duration of a discontinuous reception cycle that comprises the control channel monitoring occasion, and performance of the operation comprises one or more of maintenance of an inactivity timer as deactivated after reception of a control channel message during the control channel monitoring occasion, a changing of a transmission configuration indicator state associated with control channel monitoring, a monitoring for wake up signals by the low power radio of the UE, deactivation of the discontinuous reception cycle, activation of wake up signal-triggered control channel monitoring, a skipping of monitoring of one or more control channel monitoring occasions, a switching of a search space set group associated with the UE, and activation of communications via a secondary cell, a frequency range, or both.

Aspect 29: The method of any of aspects 19 through 28, further comprising: initiating an on duration timer associated with a discontinuous reception cycle based at least in part on the type of the wake up signal that corresponds to an active duration of the discontinuous reception cycle that comprises the control channel monitoring occasion.

Aspect 30: The method of any of aspects 19 through 29, further comprising: monitoring for the wake up signal outside of an active duration of a discontinuous reception cycle in accordance with a wake up signal monitoring configuration, wherein the wake up signal is received based at least in part on monitoring for the wake up signal.

Aspect 31: The method of any of aspects 19 through 30, further comprising: monitoring for the wake up signal within an active duration of a discontinuous reception cycle in accordance with a wake up signal monitoring configuration.

Aspect 32: The method of any of aspects 19 through 27 and 28 through 31, wherein the type of the wake up signal is associated with an active duration of a discontinuous reception cycle that does not comprise the control channel monitoring occasion, and performance of the operation comprises one or more of a skipping of monitoring of one or more wake up signal monitoring occasions, initiation of the monitoring for a control channel message during the control channel monitoring occasion a time interval after the wake up signal is received, activation of the main radio of the UE to an alertness level, transmission of a sounding reference signal by one or more antennas of the UE, transmission of channel state information by the one or more antennas of the UE, a monitoring of a wake up signal monitoring occasion by the low power radio of the UE, deactivation of the main radio, and a changing of a wake up signal monitoring configuration of the UE.

Aspect 33: A method for wireless communication at a network entity, comprising: output a wake up signal that corresponds to a control channel monitoring occasion for a UE and indicates control bits via a low power waveform receivable by a low power radio that is different from a main radio, wherein the control bits indicate one or more operations to be performed at the UE according to a type of the wake up signal; and communicating with the UE based at least in part on the one or more operations indicated by the control bits according to the type of the wake up signal.

Aspect 34: The method of aspect 33, wherein the type of the wake up signal is based at least in part on whether the control channel monitoring occasion occurs within an active duration of a discontinuous reception cycle.

Aspect 35: The method of any of aspects 33 through 34, wherein a value of a first control bit of the control bits indicates the type of the wake up signal, the one or more operations are performed based at least in part on one or more remaining control bits of the control bits that exclude the first control bit, and the one or more remaining control bits indicate the one or more operations based at least in part on the value of the first control bit.

Aspect 36: The method of any of aspects 33 through 35, wherein the control bits comprise a bitmap format to indicate the one or more operations, a value of a control bit of the control bits indicates to perform the one or more operations, or the control bits comprise a codepoint format to indicate the one or more operations, a codepoint value of one or more of the control bits indicates to perform the one or more operations.

Aspect 37: The method of aspect 36, wherein the one or more operations are indicated by the bitmap format of the control bits or the codepoint format of the control bits based at least in part on the type of the wake up signal.

Aspect 38: A UE for wireless communication, one or more memories storing processor-executable code, and one or more processors coupled with the one or more memories and individually or collectively operable to execute the code to cause the UE to perform a method of any of aspects 19 through 32.

Aspect 39: A UE for wireless communication, comprising at least one means for performing a method of any of aspects 19 through 32.

Aspect 40: A non-transitory computer-readable medium storing code for wireless communication, the code comprising instructions executable by one or more processors to perform a method of any of aspects 19 through 32.

Aspect 41: A network entity for wireless communication, comprising one or more memories storing processor-executable code, and one or more processors coupled with the one or more memories and individually or collectively operable to execute the code to cause the network entity to perform a method of any of aspects 33 through 37.

Aspect 42: A network entity for wireless communication, comprising at least one means for performing a method of any of aspects 33 through 37.

Aspect 43: A non-transitory computer-readable medium storing code for wireless communication, the code comprising instructions executable by one or more processors to perform a method of any of aspects 33 through 37.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive a wake up signal that corresponds to a control channel monitoring occasion for the UE and indicates control bits via a low power waveform that is receivable by a low power radio of the UE, wherein the low power radio is different from a main radio of the UE; and
perform an operation indicated by the control bits according to a type of the wake up signal.

2. The apparatus of claim 1, wherein the type of the wake up signal is based at least in part on whether the control channel monitoring occasion occurs within an active duration of a discontinuous reception cycle.

3. The apparatus of claim 1, wherein a value of a first control bit of the control bits indicates the type of the wake up signal.

4. The apparatus of claim 3, wherein:
the operation is performed based at least in part on one or more remaining control bits of the control bits that exclude the first control bit, and
the one or more remaining control bits indicate the operation based at least in part on the value of the first control bit.

5. The apparatus of claim 1, wherein:
the control bits comprise a bitmap format to indicate the operation, wherein a value of a control bit of the control bits indicates to perform the operation; or
the control bits comprise a codepoint format to indicate the operation, wherein a codepoint value of one or more of the control bits indicates to perform the operation.

6. The apparatus of claim 5, wherein the operation is indicated by the bitmap format of the control bits or the codepoint format of the control bits based at least in part on the type of the wake up signal.

7. The apparatus of claim 5, wherein a value of a first control bit of the control bits indicates whether one or more remaining control bits of the control bits that exclude the first control bit comprise the bitmap format or the codepoint format to indicate the operation.

8. The apparatus of claim 1, wherein a resource in which the wake up signal is received indicates the type of the wake up signal.

9. The apparatus of claim 1, wherein the one or more processors are further configured to cause the UE to:
receive control signaling that indicates one or more first wake up signal monitoring occasions that corresponds to wake up signals of a first type and indicates one or more second wake up signal monitoring occasions that correspond to wake up signals of a second type, wherein the wake up signal is received based at least in part on the one or more first wake up signal monitoring occasions or the one or more second wake up signal monitoring occasions.

10. The apparatus of claim 1, wherein:
the type of the wake up signal is associated with an active duration of a discontinuous reception cycle that comprises the control channel monitoring occasion, and
performance of the operation comprises one or more of maintenance of an inactivity timer as deactivated after reception of a control channel message during the control channel monitoring occasion, a changing of a transmission configuration indicator state associated with control channel monitoring, a monitoring for wake up signals by the low power radio of the UE, deactivation of the discontinuous reception cycle, activation of wake up signal-triggered control channel monitoring, a skipping of monitoring of one or more control channel monitoring occasions, a switching of a search space set group associated with the UE, and activation of communications via a secondary cell, a frequency range, or both.

11. The apparatus of claim 1, wherein the one or more processors are further configured to cause the UE to:
initiate an on duration timer associated with a discontinuous reception cycle based at least in part on the type of the wake up signal that corresponds to an active duration of the discontinuous reception cycle that comprises the control channel monitoring occasion.

12. The apparatus of claim 1, wherein the one or more processors are further configured to cause the UE to:
monitor for the wake up signal outside of an active duration of a discontinuous reception cycle in accordance with a wake up signal monitoring configuration, wherein the wake up signal is received based at least in part on monitoring for the wake up signal.

13. The apparatus of claim 1, wherein the one or more processors are further configured to cause the UE to:
monitor for the wake up signal within an active duration of a discontinuous reception cycle in accordance with a wake up signal monitoring configuration.

14. The apparatus of claim 1, wherein:
the type of the wake up signal is associated with an active duration of a discontinuous reception cycle that does not comprise the control channel monitoring occasion, and
performance of the operation comprises one or more of a skipping of monitoring of one or more wake up signal monitoring occasions, initiation of the monitoring for a control channel message during the control channel monitoring occasion a time interval after the wake up signal is received, activation of the main radio of the UE to an alertness level, transmission of a sounding reference signal by one or more antennas of the UE, transmission of channel state information by the one or more antennas of the UE, a monitoring of a wake up signal monitoring occasion by the low power radio of the UE, deactivation of the main radio, and a changing of a wake up signal monitoring configuration of the UE.

15. An apparatus for wireless communication at a network entity, comprising:
one or more memories; and
one or more processors coupled with the one or more memories and configured to cause the network entity to:
output a wake up signal that corresponds to a control channel monitoring occasion for a UE and indicates control bits via a low power waveform receivable by a low power radio that is different from a main radio, wherein the control bits indicate one or more operations to be performed at the UE according to a type of the wake up signal; and
communicate with the UE based at least in part on the one or more operations indicated by the control bits according to the type of the wake up signal.

16. The apparatus of claim 15, wherein the type of the wake up signal is based at least in part on whether the control channel monitoring occasion occurs within an active duration of a discontinuous reception cycle.

17. The apparatus of claim 15, wherein:
a value of a first control bit of the control bits indicates the type of the wake up signal,
the one or more operations are performed based at least in part on one or more remaining control bits of the control bits that exclude the first control bit, and
the one or more remaining control bits indicate the one or more operations based at least in part on the value of the first control bit.

18. The apparatus of claim 15, wherein:
the control bits comprise a bitmap format to indicate the one or more operations, wherein a value of a control bit of the control bits indicates to perform the one or more operations, or
the control bits comprise a codepoint format to indicate the one or more operations, wherein a codepoint value of one or more of the control bits indicates to perform the one or more operations.

19. The apparatus of claim 18, wherein the one or more operations are indicated by the bitmap format of the control bits or the codepoint format of the control bits based at least in part on the type of the wake up signal.

20. A method for wireless communications at a user equipment (UE), comprising:
receiving a wake up signal that corresponds to a control channel monitoring occasion for the UE and indicates control bits via a low power waveform that is receivable by a low power radio of the UE, wherein the low power radio is different from a main radio of the UE; and
performing an operation indicated by the control bits according to a type of the wake up signal.
